(19) United States
(12) Patent Application Publication
(10) Pub. No.: US 2026/0046108 A1
(43) Pub. Date: Feb. 12, 2026

(54) Agile Machine Cryptography Based On Real-Time Computer Function Transformation

(71) Applicant: Peter Lablans, Morris Township, NJ (US)

(72) Inventor: Peter Lablans, Morris Township, NJ (US)

(21) Appl. No.: 19/364,687

(22) Filed: Oct. 21, 2025

Related U.S. Application Data
(63) Continuation-in-part of application No. 19/076,781, filed on Mar. 11, 2025, now Pat. No. 12,476,789.
(63) Continuation-in-part of application No. 18/741,663, filed on Jun. 12, 2024.
(60) Provisional application No. 63/573,331, filed on Apr. 2, 2024.
(60) Provisional application No. 63/726,453, filed on Nov. 29, 2024.
(60) Provisional application No. 63/747,282, filed on Jan. 20, 2025.
(60) Provisional application No. 63/796,910, filed on Apr. 29, 2025.

(51) Int. Cl. H04L 9/00

(52) U.S. Cl. CPC H04L 9/006

(57) ABSTRACT

Data is processed by cryptographic operations selected from encryption, decryption, hashing, and public key exchange (PKI). Data elements are processed as n-state data elements with n an integer at least greater than 2 based on an n-state reversible n-state inverter. The n-state reversible inverter is a self-propagating n-state inverter generating different other n-state reversible inverters. The n-state reversible inverter is derived from a sequence of n n-state data elements with at least a first n-state data element occurring at least twice in different positions in the sequence and a second n-state data element not occurring. The n-state reversible inverter is created from the sequence of n-state data elements. A sequence of n n-state elements is created from a set of k n-state elements with k smaller than n. The k n-state elements are provided by a public key exchange or PKI method.

### CROSS-REFERENCE TO RELATED APPLICATIONS

This application is a continuation-in-part of and claims the benefit of U.S. patent application Ser. No. 19/076,781 filed on Mar. 11, 2025. This application is a continuation-in-part of and claims the benefit of U.S. patent application Ser. No. 18/741,663 filed on Jun. 12, 2024. This application claims the benefit of U.S. Provisional Application 63/796,910 filed on Apr. 29, 2025. This application claims the benefit of U.S. Provisional Application 63/747,282 filed on Jan. 20, 2025. This application claims the benefits of U.S. Provisional Application 63/726,453 filed on Nov. 29, 2024. U.S. patent application Ser. No. 18/741,663 claims the benefit of U.S. Provisional Application 63/573,331 filed on Apr. 2, 2024. All of the above cases and applications mentioned above are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Machine or computer based cryptography is nowadays essential for securely exchanging data over the Internet. But data, either in transit over networks and/or stored on what may be called In-Cloud servers at rest, is subject to almost continuous attacks and especially theft by malfeasants, including by state sponsored attackers, who may have almost unlimited means to attack and/or try to decrypt confidential data. While intrusion detection and prevention are important, certain detected Advanced Persistent Threats (APTs) seem unavoidable. In that context secure (unbreakable) encryption is important.

Commonly, standard cryptographic methods and primitives are used. These include encryption such as AES, AES-CTR, AES-GCM, ChaCha20 and versions thereof, hashing methods such as SHA256/512m SHA-3 for authentication as well as digital signature schemes such as DSA, RSA, EdDSA, ECDSA, Pairing Based Signatures, Schnorr digital signature, Dilithium, SPHINCS+ and others. All these methods are extensively described, implemented and tested and easily accessible to one of ordinary skill. Often in downloadable form from Github for instance.

Current hashing and digital signature schemes are mostly static in the sense that for each hashing or signature the same computer functions are applied. Customization may be attempted by key based nonces or using keys as a variable. Thus, little entropy is created after key generation, unless runtime elements like nonces or timestamps are introduced. High predictability under certain threat models, especially if nonce reuse or weak randomness enters the picture. Customization is often bolted on, via hash tweaks, domain separation tags, or multiparty protocols—rather than being baked into the compositional structure.

For at least the above reasons, methods and devices are required that improve security of current machine cryptography for encryption, hashing, validation, authentication and signatures at sufficient levels that will successfully resist breaking, man-in-the-middle and other attacks, without substantially adversely affecting computer performance.

### SUMMARY OF THE INVENTION

In accordance with an aspect of the present invention, a computer implemented method for cryptographic data processing is provided, comprising: generating, by one or more processors, from a sequence represented by p bits an n-state reversible inverter of n n-state elements, with n an integer n=2\hat{ }k greater than 8 and k greater than 3 and p being smaller than n*k; transforming, by the one or more processors, a computer function characterized by an operation on a word of bits in a cryptographic operation based on the n-state reversible inverter, the cryptographic operation is selected from the group consisting of an encryption, a hashing, a public key exchange, a digital signature generation; and transmitting data generated based on the cryptographic operation on a physical channel to another computing device.

In accordance with another aspect of the present invention, a computer implemented method for cryptographic data processing is provided, wherein n is an integer greater than 127.

In accordance with yet another aspect of the present invention, a computer implemented method for cryptographic data processing is provided, further comprising the cryptographic operation being an encryption and the one or more processors modifying a 2 operand computer function based on the reversible n-state inverter.

In accordance with yet another aspect of the present invention, a computer implemented method for cryptographic data processing is provided, wherein the cryptographic operation is an encryption and the one or more processors modifying a set of 2 or more bits by an inversion based on the reversible n-state inverter.

In accordance with yet another aspect of the present invention, a computer implemented method for cryptographic data processing is provided, wherein the cryptographic operation is an encryption and the one or more processors shuffling a set of 2 or more bits based on the reversible n-state inverter.

In accordance with yet another aspect of the present invention, a computer implemented method for cryptographic data processing is provided, further comprising the one or more processors generating a next n-state reversible inverter based on the n-state reversible inverter.

In accordance with yet another aspect of the present invention, a computer implemented method for cryptographic data processing is provided, further comprising the one or more processors generating a new n-state reversible inverter by a lexicographical permutation of at least a part of prior n-state reversible inverter.

In accordance with yet another aspect of the present invention, a computer implemented method for cryptographic data processing is provided, wherein the sequence represented by p bits is a Public Key Infrastructure (PKI) defined key.

In accordance with yet another aspect of the present invention, a computer implemented method for cryptographic data processing is provided, further comprising: the one or more processors expanding the sequence of p bits to a sequence of at least n*k bits; the one or more processors determining duplicate n-state elements and missing n-state elements in the sequence of at least n*k bits; and the one or more processors replacing a duplicate n-state element with a missing n-state element.

In accordance with yet another aspect of the present invention, a computer implemented method for cryptographic data processing is provided, wherein the n-state reversible inverter is reduced to an r-state reversible inverter and the computer function is an r-state computer function with r<n.

In accordance with yet another aspect of the present invention, a computer implemented method for cryptographic data processing is provided, wherein transforming, by the one or more processors of the computer function is performed by a Finite Lab Transform.

In accordance with yet another aspect of the present invention, a computer implemented method for cryptographic data processing is provided, wherein the computer function is characterized as a 2-operand commutative involution or self reversing function that does not comply with all requirements of an addition over a finite field.

In accordance with yet another aspect of the present invention, a computer implemented method for cryptographic data processing is provided, wherein transforming, by the one or more processors of the computer function includes a carry-function.

In accordance with a further aspect of the present invention a cryptographic data processing device is provided, comprising: one or more processors; one or more memory devices, configured to provide instructions to the one or more processors to perform the steps: generating, from a sequence represented by p bits an n-state reversible inverter of n n-state elements, with n an integer n=2\hat{ }k greater than 8 and k greater than 3 and p being smaller than n*k; transforming, by the one or more processors, a computer function characterized by an operation on a word of bits in a cryptographic operation based on the n-state reversible inverter, the cryptographic operation is selected from the group consisting of an encryption, a hashing, a public key exchange, a digital signature generation; and transmitting data generated based on the cryptographic operation on a physical channel to another computing device.

In accordance with yet a further aspect of the present invention a cryptographic data processing device is provided, wherein n is an integer greater than 127.

In accordance with yet a further aspect of the present invention a cryptographic data processing device is provided, wherein the cryptographic operation is an encryption and a 2 operand computer function is modified based on the reversible n-state inverter.

In accordance with yet a further aspect of the present invention a cryptographic data processing device is provided, further comprising the step generating a next n-state reversible inverter based on the n-state reversible inverter.

In accordance with yet a further aspect of the present invention a cryptographic data processing device is provided, wherein the sequence represented by p bits is a Public Key Infrastructure (PKI) defined key.

In accordance with yet a further aspect of the present invention a cryptographic data processing device is provided, wherein the computer function is characterized as a 2-operand commutative involution or self reversing function that does not comply with all requirements of an addition over a finite field.

In accordance with yet a further aspect of the present invention a cryptographic data processing device is provided, wherein transforming, by the one or more processors of the computer function includes a carry-function.

In accordance with yet a further aspect of the present invention a cryptographic data processing device is provided, wherein the cryptographic operation is an ASCON encryption as defined in National Institute of Standards and Technology Special Publication SP.800-232 and a 2 operand computer function is modified based on the reversible n-state inverter.

### BRIEF DESCRIPTION OF DRAWINGS

FIG. 1 is a diagram of a device that modifies a switching operation in accordance with one or more aspects of the present invention;

FIG. 2 is a screenshot of a Matlab program in accordance with one or more aspects of the present invention;

FIGS. 3 and 4 are screenshots of computer implemented lookup tables in accordance with one of more aspects of the present invention;

FIGS. 5 and 6 are screenshots of Matlab programs in accordance with one or more aspects of the present invention;

FIGS. 7, 8, 9, 10 and 11 are screenshots of Matlab generated data tables generated in accordance with one or more aspects of the present invention;

FIG. 12 is a screenshot of prototype data table generated by a computer;

FIG. 13 is a screenshot of a computerized lookup table in accordance with at least an aspect of the present invention;

FIGS. 14, 15, 16, 17, 18 and 19 are screenshots of modified computerized lookup tables generated by a computer in accordance with one or more aspects of the present invention;

FIG. 20 is a screenshot of a Matlab program in accordance with one or more aspects of the present invention;

FIG. 21 is an illustrative diagram of a computing device;

FIG. 22 is a diagram illustrating a network;

FIG. 23 is a screenshot of a computerized lookup table as implemented in Matlab;

FIGS. 24 and 25 are screenshots of modified lookup tables in accordance with at least one aspect of the present invention;

FIG. 26 illustrates in block diagram a transformation of a computer device in accordance with at least one aspect of the present invention;

FIG. 27 illustrates a screenshot of an 8-state carry function that may be applied in a reversible radix-8 addition in accordance with an aspect of the present invention;

FIG. 28 illustrates a screenshot of an 8-state borrow function that may be applied in a radix-8 subtraction that reverses a radix-8 addition in accordance with an aspect of the present invention; and

FIG. 29 is a block diagram of a computer procedure that modifies a sequence of n-state elements into a reversible n-state inverter.

### DETAILED DESCRIPTION OF THE INVENTION

A computer is a switching machine. It has devices that switch through two or more states in accordance with a pre-established pattern. These patterns are commonly described as two-operand logic functions like XOR, AND, OR, NAND, or other binary logic functions. The logic function states are often described as numbers such as 0 and 1. However, there are no actual 0s and 1s inside a device. The 0s and 1s are symbolic descriptions by humans of the physical states of a switching machine.

In modern computer machinery, the binary states of switching devices are technically indicated by being either LOW or HIGH. What LOW and HIGH mean depends on the applied technology. In TTL switching devices, a LOW voltage may be between 0V and 0.8V, and a HIGH voltage may be between 2V and 5V. In standard CMOS devices, a LOW voltage may be between 0V and 1.5V, and a HIGH voltage may be between 3.5V and 5V. One may assign the logic value 0 to a LOW voltage and the logic value 1 to a HIGH voltage, but the reverse is also known.

Dr. Gerrit Blaauw was the inventor's professor in computer design. He explains that a computer design is described at a hierarchy of three levels: 1) the architecture, disclosing (to the system programmer) what the device does, 2) the implementation or logic, a functional (logic) description of how the function is realized by available functional components, and 3) the physical realization of real components that realize a functional requirement. In his book Digital System Implementation and later in his book Computer Architecture, which are both incorporated herein by reference, uses executable APL instructions to create digital circuitry. The significance of executable code like APL or Matlab or others is that it establishes a true physical realization. That is, the instructions, when executed, are not merely an abstract idea or a description; they establish a real-life physical circuit. While one may observe the description of a design of this circuitry in terms of functional expressions, they represent an actual physical circuit.

The distinction between what a computer does and how it does it seems to have been lost. However, review of the original MIT Master Thesis of Claude Shannon in 1938 entitled “A Symbolic Analysis of Relay and Switching Circuits, reminds that symbolic representation of states was applied to facilitate circuit design. Internally, even in Shannon, no numbers exist inside a circuit. In Shannon circuit states (relays impedance or “hindrance” as Shannon calls it) is provided with an external label). These labels of course do not exist physically in the circuits.

Aspects of the invention disclosed herein, while for convenience described in terms of mathematical looking expressions and numerical states, are directed toward physical structures and require devices like configurable processors and memories and the like, and are not directed to an abstract idea. They all realize physical structures that have causal physical states. While in general programmable processors are built from active electronic devices, one could also replace them with addressable memory devices that store the required truth table. This may be applied in Read-Only-Memory (ROM) and in devices such as Programmable Logic Devices (PLDs) and Field Programmable Gate Arrays (FPGAs) as well as programmable processors, GPUs and multi-core processors

One of ordinary skill in the art of computing devices knows that these devices, are physical devices. The storing of a lookup table is a physical process, and no “numbers” are stored. Only physical states are created. One reason to point out these well-known facts here is that some people, generally not well-versed in computer design and/or realization, often believe that computers process numbers. But as explained above and well-known in the engineering literature, computers and processors do not do such a thing. The appearance of number symbols occurs by apparatus that make it appear that numbers are inputted or displayed. For instance, when hitting a key 8 on a computer keyboard, a signal is generated that may be represented by a number 8. Similarly, when a computer display shows a number 8, it is the activation of light-emitting elements by a computer-generated signal that lights up as 8 on the display. Internally a computer applies binary L/H signals. Conversions of output signals to display numbers and key input to signals are well-known, but not always recognized.

Switching operations may be described in terms of Boolean algebra or other mathematical terms. For instance, a bitwise XORing of words of 8 bits may be described as an addition over GF(256). But this is merely the description. In effect, the computer does not perform an addition over GF(256) as those concepts do not exist inside a computer. Still, for functional description, the use of addition over GF(256) is appropriate. But it goes with the understanding that this is merely a functional description of an operation. Tt is the logic implementation equivalent, in the sense of the teachings of Blaauw, of a physical realization. This applies for all descriptions of operations following herein. This means that when an operation or function, even when described by a mathematical term or by a lookup table, is programmed on a computer and generates an expected and/or valid result, then as taught by Blaauw, there is a physical realization, and the description herein is directed to a device herein and not to an abstract idea.

In that sense, a computer function herein, such as an addition modulo-n, for instance, is not merely a functional description. It corresponds to a structured physical device that performs in accordance with one or more logic operations that may be represented by the function addition modulo-n. The actual structure may, for instance, be a carry ripple adder structure in an Arithmetic Logic Unit (ALU) of a processor.

It would be tiresome and very hard to understand if computing functionality and devices were to be explained on a component schematic level. For the reason of simplicity and transparency, mathematical and functional terms are used with the understanding that a physical structure for doing the function exists or will be configured by instructions in the processor or device. For that reason, all functional and mathematical terms used herein are a (high level) description of a physical structure in a processor or switching device. But without exception herein a computer function is a physical device. One may check this with for instance electrical probes to determine a physical state of an input or output of a device. Thus, the term function herein explicitly and verifiably is a term that is equivalent to a physical device.

The Finite Lab-Transform (FLT) was invented and described for instance in U.S. Pat. No. 11,336,425 to Peter Lablans issued on May 17, 2022 which is incorporated herein by reference. The FLT requires an n-state reversible inverter (invn), its reversing n-state inverter (rinvn), so that the two inverters in combination provide identity or: invn (rinvn (x))=x and rinv (invn (x))=x for all x being n-state elements, and a 2-operand n-state function. An n-state reversible inverter may be represented by a sequence on n different n-state elements, each n-state element having a position in the sequence an an n-state designator often called value. In computer implementation it may be stored as an 1D array such as “invn.” For instance an 8-state reversible inverter may be inv8=[2 3 4 5 6 7 8 1]. Positioning of the 8-state elements is by origin-1 in Matlab. That is the first position in the sequence has index 1 and the final element has position 8. This is in variance with other representations where a first position has index 0 or origin-0. In that case the element indicators are usually selected from {0, 1, 2, . . . , n-1}. A n-state reversible inverter has a reversing inverter ‘rinvn.’ A property of a combination of n-state reversible inverter and reversing inverter is that rinvn(invn(x))=x.

The FLT works as follows: call the input operands a and b (which are preferably represented as n-state operands) and the 2-operand function is fun(a,b) with c-fun(a,b). The input operands are inverted with n-state reversible inverter invn, then the inverted operands are applied in operation fun and the result of this operation is reversed inverted with rinvn. Or according to expressions: ai-invn(a); bi-invn(b); c-fun(ai,bi); and out is out=rinvn(c) or out=rinvn(fun(ai,bi)) or out=rinvn(fun(invn(a),invn(b))). One may also determine out=funflt(a,b). The function funflt is then a modified switching table of switching table fun. One may determine funflt LUT (look-up table) by running through all possible n-state input operands and applying a LUT for invn and rinvn. This has been done for instance for LUTs representing addition over GF(256) that are FLTed. Such a table requires a memory of 65 Kbyte. By itself not very small, but in the context of available memory in current computing devices negligible in size.

The FLT either as apparatus or as method implemented on an apparatus is illustrated in FIG. 1. A device 100 performs an n-state 2 operand operation, like an addition over GF(n), for instance implemented as a bitwise XOR of words of k bits so n=2\hat{ }k. Device 100 has two inputs: 105 and 106 to receive the n-state operands, each operand is inverted by n-state inverter 101 and 102, respectively before entered upon inputs 108 and 109, respectively. FLT inverters 101 and 102 are preferably identical. The device may optionally have a signal input 112, for a signal to enable or start execution of operation 100. The resulting n-state output signal is provided on 110. This n-state signal is then inverted by reversing inverter 103. If one calls 101 inverter ‘invn’ then 103 may be called ‘rinvn” and invn(rinvn(x))=x indicating that the combination of invn and rinvn is identity. The resulting (and FLTed) signal is provided on output 107. The FLT is generally meta-properties preserving. That is, if 100 is characterized as an addition over GF(n) then the FLTed operation is also an addition over GF(n). Even though the numerical representation may be modified. One may use all elements as separate look-up tables. One may also represent the operation between inputs 105 and 106 and output 107, as its own lookup table as for instance an n by n n-state table. While the FLT is illustrated in a 2-operand example, the FLT may be applied to any p-dimensional operation or p-operand operation.

There are different ways to perform an FLT. One such way is to modify the rows and columns of the switching table in accordance with the n-state inverter at the input of the operation to generate an intervening table. Then apply the reversing inverter to the states of the intervening table. This may be a table-based transformation rather than individual state transformation. However, the resulting function is identical.

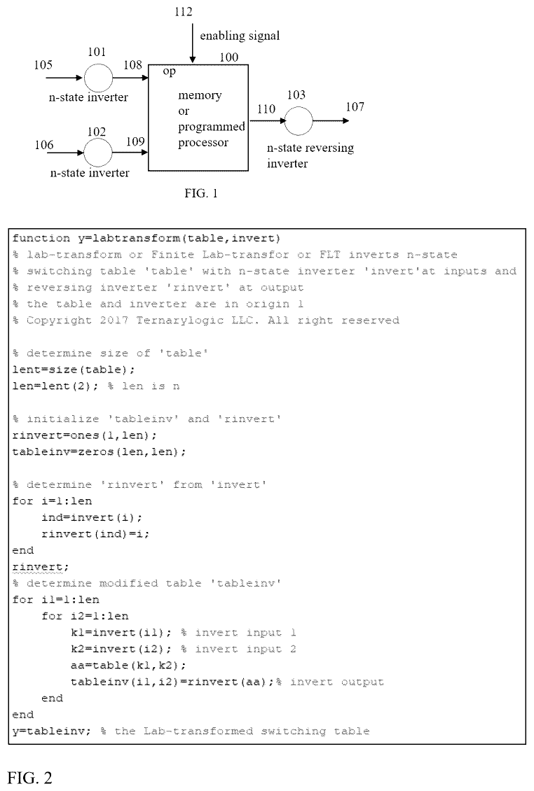

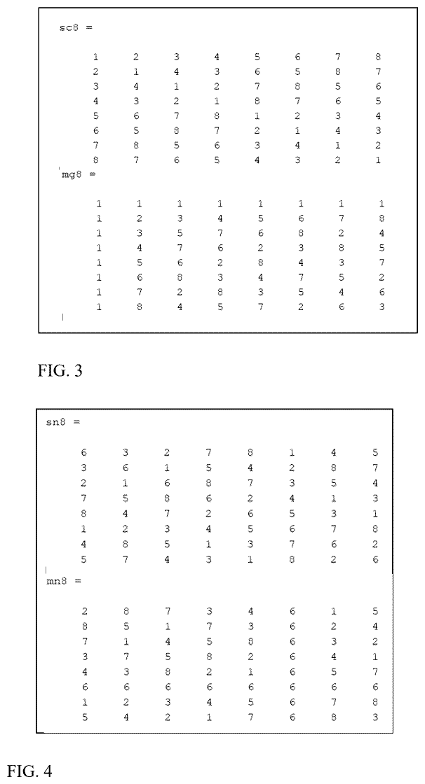

FIG. 2 shows a screenshot of a working Matlab program that performs the FLT. FIG. 3 is a screenshot of tables of an 8-state addition over GF(8) and a related multiplication over GF(8) establishing a finite field GF(8) in origin-1. FIG. 4 is a screenshot of the tables realized with the FLT program of FIG. 2 to output an FLTed-version of the addition and multiplication as shown in FIG. 3. One may notice in FIG. 4 is table sn8 the column/row with index 6 being identity and columns/row 6 in mn8 in FIG. 4 having the same states (now 6 being the zero-element).

The FLT has been applied by the inventor in cryptographic programs in Matlab and Python and C as lookup tables and the use of LUTs actually makes the machine execution if not faster at least not slower than application of standard and unchanged functions. This has been done in applications such as SHA-256, AES-GCM, ChaCha20 as described on website lcip.in. The FLT requires both the n-state inverter and the corresponding n-state reversing inverter to be performed. One may do this FLT in real-time, using a rule based or an LUT set of inverters, or one may do this off-line and compute the condensed look-up switching table funflt and store it for later use. Again, for smaller values of n like n=256 up to perhaps n=4096 one can create LUTs. However, for much larger n like n being represented by 256 bits for instance, creating and storing an LUT is infeasible. In that case the FLT has to be applied with its components. That is inverting operands, then processing the inverted operands and reverse inverting the result.

For consistency and clarity, the inverters for the input operands are called the n-state reversible inverters and the inverter at the output is called the reversing inverter.

An n-state inverter may be stored in a look-up table. But it may also be programmed as a rule or an expression. For instance, one may have as inversion rule: invn (x)=xi=d*x+h modulo-n. The inversing inverter rule is then x=(xi-h) *d\hat{ }-1 modulo-n, with x, xi, d and h all being n-state elements. The factor d\hat{ }-1 may be computed using the Extended Euler Algorithm (EEA). One may make more complicated rules. For instance, one may divide the range of generated inversions in 2 equal parts and interleave the parts in a reversible way. This disturbs any linearity that existed.

One may desire to do an FLT of a large function like an addition over GF (2\hat{ }32). The function itself is a bitwise XOR or words of 32-bits. The number 2\hat{ }32 is about 4billion. A 2\hat{ }32 state inverter would require generating as well as storing 4*2\hat{ }32 bytes or about 16 GBytes. And one would need to do the same for the reversing 2\hat{ }32 state inverter. While not impossible, it would consume much of available storage space and RAM even in desktop computers. The operation of XORing words of 32 bits is very fast as this may happen by parallel processing.

The above provided method of individual element inversion and reverse inversion is very fast. Suppose one wants to do y=sn32bits(x1,x2) wherein x1 and x2 are 32-bit operands and sn32bits is the FLT of sc32bits which is the XORing of 32 bits words.

An n-state inversion by a feedback shift register or FSR is explained in U.S. patent application Ser. No. 18/741,663 to Lablans, filed on Jun. 12, 2024 which is incorporated herein by reference. The FSR method allows inversions of very large words of bits, for instance of 800 bits. An inversion is then a number of s shifts of the FSR and a reverse inversion is the running of an FSR in its reverse direction. The operand is a content of the shift register. Thus a fast and simple 32-bit inverter may be realized with a 256-state maximum length FSR with a shift register of 4 256-state (8 bit) elements. The coefficients of the maximum length FSR may be determined using known functionality in Magma Calculator to generate a irreducible polynomial over GF(256) of degree 4.

While it may be beneficial to store and use complete n by n n-state switching tables or look-up tables, the approach of using the FLT with individual inverters or inverter rules is also very fast and does not require large memory space.

In accordance with an aspect of the present invention, one may FLT the ‘+’ operation with its own rule based n-state inversion ind_plus-aa plus*x+ss_plus and its corresponding reversing inverter. One may also replace ‘+’ with the bitwise XOR of the two operands like: ginv=aa⊗g⊕ss. This makes the reversing inverter simpler as x=aai⊗(ginv⊕ss).

An effective “inversion” is a change in the representation of a key or common key in an encryption. One may agree for device 1 and device 2 to use a common modification of a 256 bit word. The common key is represented as 256 bits with leading zeros if need be. Both devices already have achieved a common key even before reverse inversion, for instance via PKI. One may do the additional inversion before or after or even instead of the reverse inversion. Such an inversion may be one way, but may also be reversible, even though there is no need for reversing it. As an illustrative example, one may use: take the 256 bit sequence and shift it k bits in a circular way. For instance, take k bits from the left side of the sequence and place them on the right side of the sequence. Then cut the shifted sequence in m equal parts. And then, for instance starting from the back forward, form a new sequence by taking a bit from each part and place them in consecutive positions in the new sequence, moving through the parts until all bits have been placed.

The inverter ‘invn’ is reversed by reversing inverter ‘rinvn’ which may be obtained for instance by the rule rinvn(invn(x))=x. Of course, rinvn and invn may be switched in meaning, so rinvn is the inverter and invn is the reversing inverter. One may apply this type of inversion on key generation, such as Diffie Hellman, classical and elliptic curve based, on RSA and ElGamal as well as others including post quantum PKI.

One transformation is a reversible shuffling. A sequence of p elements may reversibly be shuffled by a p-state reversible inverters. Another transformation is the n-state inversion. That is, one applies an n-state reversible inverter (if one wants a reversible transformation) to n-state symbols in a stream of n-state elements.

For instance a 16-state element may be represented by a word of 4 bits, which may be represented as word−[1 2 3 4] wherein 1, 2, 3 and 4 represent the position of a bit. Each position may be occupied by a bit being 0 or 1. For instance bin41=[1 0 0 0] or bin42=[1 1 0 0] etc. The representation inv4=[2 3 4 1] provides a scheme for reversibly shuffling the bits and using inv4 rule create shuffled words bin41s=[0 0 0 1] and bin42s=[1 0 0 1]. One may recover the unshuffled words by reversing rule rinv4=[4 1 2 3]: bin41u=[1 0 0 0] and bin42u-[1 1 0 0].

The advantage of bit-shuffling becomes apparent for bigger words like 32-bit words. For a 2\hat{ }8=256-state inverter, a lookup table contains of an inverter contains 256 bytes to store the inverter. Which is not a problem. For 2\hat{ }32-state inverters that is more demanding of storage requirements. But for shuffling only a 32-state inverter is required and there are at least 2*32! variations or about 4*10\hat{ }35 possible bit shuffle arrangement.

It is not required to invert a set of data as 256-state elements, even if the original documents or plaintext is constructed of bytes. One may consider a plaintext for instance as a series of 10 bits elements or words. One may then divide the data stream into a series of 10 bit equivalent elements and invert the 10-bit elements with a reversible 1024-state inverter. One may then use a k-state inverter to shuffle k elements of 7 bits for instance. Or any other useful shuffle and/or inversion. One should take care of the right size of the number of elements. And one may, as needed, apply adding meaningless symbols such as nonces, to fill up a required number of elements.

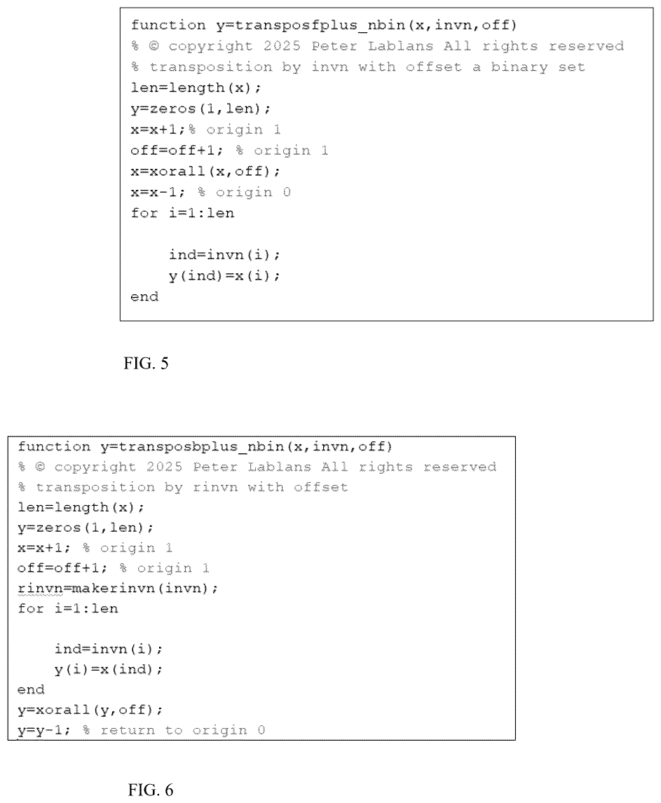

FIG. 5 and FIG. 6 show two Matlab shuffle programs with offset that create rule based n-state inverters with k-state shuffle rules. The program in FIG. 5 provides a forward rule and FIG. 6 a reversing rule.

It is to be understood that forward and reversing are relative terms as the forward shuffle may be interpreted as the reversing shuffle of the reversing shuffle.

The AES based instructions in AES-GCM/CTR are used to generate a keystream and need not to be reversible. AES has several steps. One is the Key Expansion which applies the key of 128 or 256 bit to be expanded for instance in a key array of 240 bytes. A key array is used from the key expansion as a round key. Each round in AES is applied to a state array which is an array of 16 bytes commonly represented as a 4 by 4 array of bytes. Each round also use a round key of 4 by 4 array or 16 bytes. In the applied program, the state is represented as a 256-state element array.

In one example, the 4 by 60 (-240) 256-state array of the key expansion created in one mode of AES, is shuffled by a 240-state reversible inverter created by inv240=randperm (240) for instance in Matlab. The shuffling is executed by first creating a first single row array of 240 elements from the array, then creating a second single row array wherein element of the first single row array (i) are moved to position ind=inv240(i) in the second single row array and the second single row array is converted back to a 4 by 60 array.

In an illustrative example the 240 byte key expansion array is generated from the following 256-bit key (or 32 bytes) key=‘44a74cla57da2bf6d6838956cdca13f1b67cc6ad87d459bff544784083868171’.

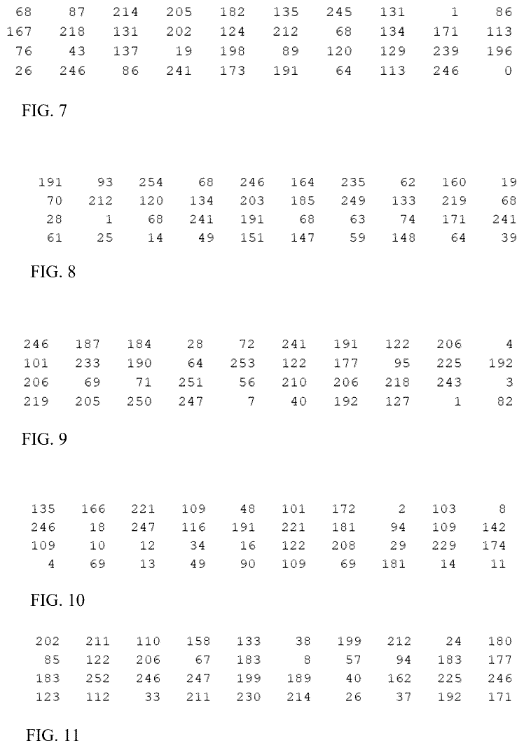

The output in Matlab of the array is a 4 by 60 256-state array, but is too large to be shown herein in its entirety. For illustrative purposes only the first part being 4 rows with 10 columns of the generated Key Expansion array is shown in a screenshot outputted by a Matlab program in FIG. 7.

In accordance with an aspect of the present invention the 256-state elements of the array are being shuffled based on reversible 240-state inverter inv240-[123 99 174 32 40 22 175 57 122 10 12 226 118] of which only the first and last 7elements are shown as 256 elements would just confuse by its large number of elements.

The modified Key Expansion array based on that shuffle in partial form (4 rows of first 10 columns) is shown in the screenshot in FIG. 8.

The ciphertext generated without shuffling may be:

C=‘6deb6e66165c0f8d85369bb6d2051d’ in accordance with an example. Using the shuffling of 256-state elements with inv240 generates ciphertext C=‘9fe6d6dfebada5923e998245142996’. This demonstrates the security effect of n-state inverter based k-state element shuffling.

In accordance with an aspect of the present invention, the Key Expansion array in AES is modified by bitwise shuffling. This is done as explained above by first arranging the 2D array into a single array, then represent all 256-state elements by its 8-bit words and concatenating all bits into a 1920 bit sequence then re-arranging into their sequence of 256-state elements and re-arranging into the applied 4 by 60 modified array. One may generate simply a 1920-state reversible inverter by inv1920=randperm(1920) to generate for instance inv1920=[1462 97 1857 1070 1005 1324 1003 951 . . . 1266 578 869 491 631 1503 1363 202] showing the first 8 and last 8 elements of the generated 1920-state reversible inverter. Using this inverter to shuffle the bits in the Key Expansion array, creates a modified Key Expansion array showing the 4 rows with 10 columns in FIG. 9.

This modified Key Expansion array together with other identical inputs generates the AES-GCM ciphertext: C=‘90a420cb55a362f80a1325146d84ac’, which is again different from the original ciphertext. Also, the authentication tag will be modified by the shuffling. However, as all AES parameters stay the same for corresponding encryption and decryption, the decryption and authentication work fine under these shuffles.

In accordance with an aspect of the present invention one applies at least two shuffles to a set of n k-state elements. That is: one applies an n-state inverter based shuffle on the n k-state elements and then do a bitwise shuffle on the shuffled n k-state elements. One may also change the order of these different shuffles with usually different outcomes as the combination of shuffles are not associative and the order of execution matters. One may also apply a k1-state shuffle followed by a k2-state shuffle wherein k1 and k2 are different. For instance, one may use the 240 element sequence of bytes or 240*8 bits and create a sequence Of 274 7 bit words and shuffle with a 274 state inverter based shuffle, reconstruct the bit sequence and shuffle again based on 11-bit words with a 174-state inverter and reconstruct again the binary representation, of course taking into account any remainder bits.

The Matlab screenshot in FIG. 10 shows the parts of the Key Expansion array generated first by inv240 byte shuffle followed by the 1920 bit shuffle. This transformation generates ciphertext C=‘792436e412e25599f11fe2a85255dc’. The result of first doing the 1920 bitwise shuffle followed by the 240-state byte shuffle is shown in screenshot of FIG. 11 and generating ciphertext C=‘4274f2798d0cc0d83350c369045657’.With the screenshots showing of course only parts of the generated Key Expansion array.

In the above disclosed shuffle, one shuffles all elements (be it k-state elements or bits or other rule) of the entire Key Expansion array. This means that in the AddRoundKey( ) module of AES only shuffled keys are applied.

It may be advantageous to only selectively per round modify the key. In that case one may shuffle the 4 by 4 256-state key array taken from the Key Expansion array. One may apply that in one round or in more rounds of a cryptographic operation. However, one may also create a separate and stored shuffled Key Expansion array and apply selectively only for certain rounds the relevant part to be the applied Key Array. In the Hill program this was done by the following:
state=AddRoundKey(state,w(:,1:4));%conducts first round
   for k=2:(Nk+6)%conducts follow-on rounds
      state=SubBytes(state);%per standard
   state=ShiftRows(state); % per standard
   state=MixColumns(state); % per standard if k==9
      state=AddRoundKey state,w2(:,4*(k-1)+1 4*k)); else
      state=AddRoundKey(state,w(:,4*(k-1)+1:4*k));
   end
end

The above shows in Matlab that for k=9 (round 9) the key is selected from w2 which is the 1920 binary/240 byte-wise shuffled Key Expansion array. One may do this for one or more rounds, with the same of different shuffles. The ciphertext generated with the single round 9 modified key array is C=‘7209319a07fabb6206a9e0e8122bf5’. Because of the inherent avalanche effect of AES, even minor changes and modifications has major effects. One may apply one or more shuffles and/or inversions of elements in a single round, in multiple rounds or even all rounds in encryption and in hash operations. One may change the k in the KeyExpansion module to generate more, for instance 256 bytes, in that case in a 4 by 64 array, which is of course a sequence of 256 bytes sequence. I may be read as a sequence of 256 bytes or 256 256-state elements, and which may be used to derive a 256-state reversible inverter.

One may also shuffle the ‘state’ array. One may do that standard for every round, for selected rounds, for all modules SubBytes (state), ShiftRows (state), MixColumns (state) and/or AddRoundKey (state), or for selected modules in selected rounds. One may shuffle before or after execution of a module, etc. One may shuffle bits and/or bytes and/or any n-state representation of bits. One may shuffle all bytes or bits in a state array or just a part like a row and/or a column in the state array or any selection of bytes or bits. The avalanche effect will affect the generated ciphertext and make it significantly different from the unshuffled data,

The following Matlab instructions show the shuffled state array applied to the MixColumns( ) and AddRoundKey( ) modules in round 9:
for k=2: (Nk+6) % conducts follow-on rounds
   state=SubBytes(state);%per standard
   state=ShiftRows(state);%per standard
if k==9
   state=shufstatebin(state,invn); end
state=MixColumns(state);%per standard
state=AddRoundKey(state,w(:,4*(k-1)+1:4*k));%per standard end

The result is a ciphertext C=‘8e0d5089d9e89110f116741dd76d57’.

The above discloses transformation of a set of data by shuffling. This means that the overall statistical make-up of the data is not modified, just the order of symbols is changed. A combination of two shuffles, the set represented as bits and the set represented as a set of words of 2 or more bits does in fact change the non-binary makeup, but not the binary make-up. Thus, like in the FLT, the shuffling does not introduce a bias towards a specific representation.

In following illustrative examples, a sequence of p bits is divided in corresponding n k-state elements with k-2\hat{ }q and thus p=q*n. This is done for convenience, not for necessity. One may use shuffles that doesn't shuffle all bits or all k-state elements. In most cases a shuffle and/or inversion of a limited set of elements is sufficient for affecting a significant output change. Theoretically, a k-state inversion of 1 element or a shuffle of 2 elements is sufficient to affect a dramatic change in ciphertext or hash. In order to have an illustrative comparison all elements are subject to shuffle or inversion in the following examples. With the understanding that one may select only a limited number of elements to modify or shuffle, up to a complete set as defined by a block or array (such as the state array) or an S-box or pre-defined constants as in SHA-256 for instance.

The modifications will affect the generated ciphertext in AES, AES-GCM, ChaCha20 and the hash in SHa-256, SHA-512, SHA3 and Keccak versions. Rather than confuse a reader with different outputs, the following illustrative approach is applied.

In a first example a 4 by 4 array of bytes will be shuffled and inverted in different order of operations. The operations are: 1) S_16 or shuffling of 16 bytes based on reversible 16-state inverter inv16; 2) S_bin128 or shuffle of 128 bits (being 16 bytes) based on 128-state inverter inv128; and 3) I_256 or 256-state inversion of each of 16 256 state symbols in the data set based on 256-state reversible inverter inv256.

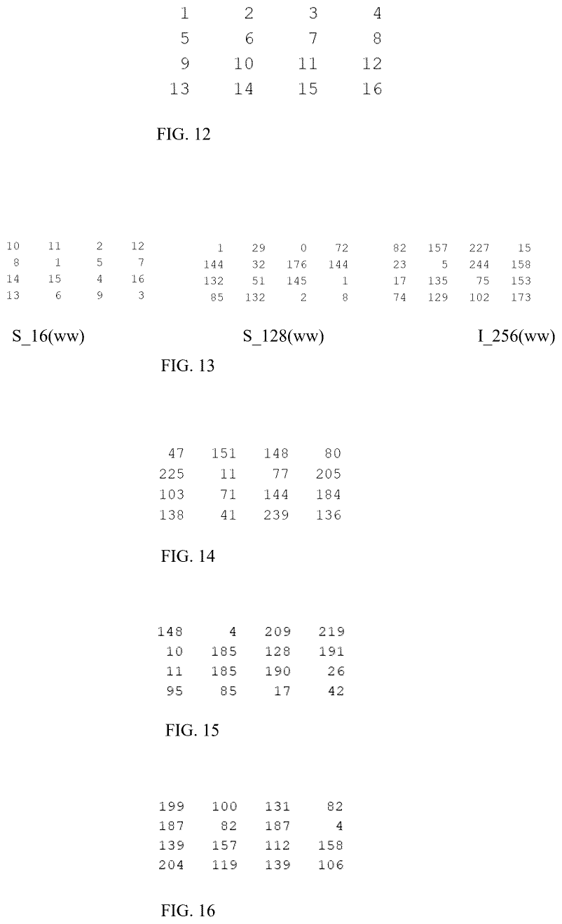

The data set is initially presented as a 4 by 4 array of 256-state elements and is shown in FIG. 12 as a Matlab screenshot. A very simple sequence seq=1:16 is read into consecutive rows. For shuffling the initial order is important and in this example the array is read row by row into a sing row array, shuffled and moved back into an array. An additional shuffling may be applied by putting a shuffled single row array back into a 4 by 4 array by filling columns, which amounts to additional shuffling.

The following inverters in Matlab origin-1 are used:
inv16=[6 3 16 11 7 14 8 5 15 1 2 4 13 9 10 12]
inv128=[61 124 22 9 89 31 71 29 53 32 47 34 64 118 104 86 48 38 97 127 63 24 88 49 85 128 19 93 101 8 66 106 20 109 122 112 73 110 59 79 126 6 68 116 94 65 100 107 50 54 56 77 74 125 102 60 45 44 95 28 12 103 67 23 1 11 27 40 33 55 82 75 90 18 108 117 105 123 14 111 15 58 99 42 57 39 81 84 92 30 83 7 80 26 3 37 115 72 10 2 43 52 17 36 121 35 113 46 51 98 16 120 91 21 5 4 13 119 70 76 69 41 25 96 114 78 62 87]
and
inv256=[107 83 158 228 16 24 6 245 159 18 136 76 154 75 130 103 174 96 111 225 149 19 249 105 255 212 144 220 39 132 80 150 120 253 52 124 119 53 99 85 38 89 160 202 14 117 170 133 208 29 168 200 61 195 219 44 201 203 97 198 238 155 233 131 134 147 58 62 56 46 54 213 113 250 216 226 91 118 35 17 70 166 221 196 180 205 87 22 222 251 84 141 42 60 189 127 65 156 243 171 143 186 73 26 146 12 242 112 129 148 214 135 1 223 207 115 204 178 25 211 104 31 179 95 164 234 82 197 64 177 231 239 140 30 139 40 47 224 181 182 128 237 88 77 188 101 236 165 51 68 123 192 74 81 153 232 122 67 43 194 215 90 217 63 126 193 240 172 185 32 163 161 256 92 37 13 5 9 241 36 252 169 93 21 48 15 33 218 254 230 162 11 167 94 45 72 34 71 10 27 108 176 78 173 145 3 86 184 28 248 114 227 187 57 109 183 157 20 100 66 55 199 7 125 110 121 191 246 49 142 137 209 116 247 98 2 69 206 229 59 175 8 79 190 151 138 23 152 50 4 41 106 235 210 244 102]

The initial array is called ‘ww’. The screenshots in FIG. 13 show the results of shuffles/inversions S_16(ww), S_128(ww) and I_256(ww).

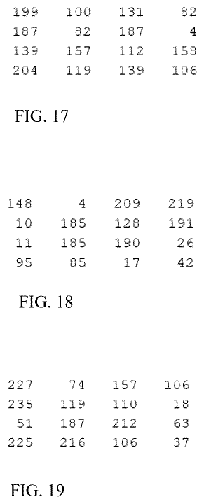

FIG. 14 in screenshot shows the result of I_256/S_128/S_16; FIG. 15 in screenshot shows the result of I_256/S_16/S_128; FIG. 16 in screenshot shows the result of S 128/1 256/S_16; FIG. 17 in screenshot shows the result of S_128/S_16/S_128; FIG. 18 in screenshot shows the result of S_16/I_256/S_128; and FIG. 19 in screenshot shows the result of S_16/S_128/1 256.

One can see that 2) 1256/S16/S128 and 5) S16/1256/S128 and 3) and 4) are associative in the sense that I256/S16 and S16/1256 provide the same output.

One can avoid such associative results by using inverters of different cardinality. For instance, one may apply (instead of a shuffle based on 8-bit or 256-state elements), a shuffle of 4-bit or 16-state elements using thus a 32-state inverter to shuffle 32 16-state elements in a 128 bit sequence. Or one may apply a 128-state inversion (not a shuffle) on elements of the array. This can be done by 1) re-arranging the 4 by 4 array of 16 bytes, into a one dimension sequence of 128 bit; 2) divide the 128 bits into 18 consecutive words of 7 bits or 126 with a remainder of 2 bits; 3) represent the 126 bits as 18 128-state elements. 4) create or generate, for instance with inv18-randperm (18) a 18-state reversible inverter; 5) shuffle the 18 128-state elements based on the 18-state inverter; 6) convert the consecutive 128-state shuffled elements into their binary representation, with the 2 unmodified bits; and 7) re-arrange the 128 bit sequence into a 4 by 4 array of 256-state elements by first dividing the sequence into consecutive words of 8 bits, of which there are 16, of course.

In accordance with an aspect of the present invention, the above combination of shuffles and/or inversion may be applied reversibly to data. AES has several modes it may operate in, defined in NIST issued specification SP 800-38D which is well known to one of ordinary skill. For purposes of this disclosure, references to NIST publications, including FIPS standards, are made solely to illustrate known cryptographic practices and are well known to persons having ordinary skill in the art of machine cryptography and/or cyber security. The same applies to standards issued as Requests for Comments (RFCs), which are cited only to reflect commonly understood protocols and practices within the field of cryptography.

In summary: one may shuffle and/or invert data on bit level and/or on n-state element level. One may do that at any stage of a cryptographic operation, such as rounds or at what are called herein “transformation points.” A transformation point in a cryptographic operation is a defined and identifiable point in a cryptographic operation. For instance: the Round Key array in AddRoundKey( ) in round 9. This forms an identifiable point that allows different machines to identify and transform in identical way.

In accordance with an aspect of the present invention a seed or base n-state inverter, which is preferably reversible, is applied to propagate additional, different n-state inverters. In Matlab and other languages that can be achieved by initiating a k-state inverter invkstart and make a copy invkb=invkstart. One then for each block generates invkb=invkstart(invkb) as a next k-state inverter. The earlier statement means invkb (i)=invkstart(invkb(i)). One may also use other variants like invkb=invkb(invkstart). Or even invkb=invkb(invkb) after initialization.

It may upfront not be entirely clear that a ‘next’ inverter is also a different inverter. For instance, there are 24 (or 2*3*4) different 4-state inverters. However, there are only a maximum of 4 different inverters 4-state inverters generated from any of the possible 24 starting inverters. That seems disappointing, as it is as good as a shifted 1 position 4-state inverter which returns to its original start after 4 shifts. A rotation or shifts of a 240-state inverters would provide 240 different 240-state inverters. Not enough for 5 million blocks.

Up to k=7 the number of 7-state inverters inverted by itself seems not to increase significantly relative to k. However, and conveniently that starts to change when k is greater than 7, as combinatorial explosion starts to kick in. The number of generated inverters before repeat suddenly starts to increase significantly.

For n=240 the self-inversion a explained above in some cases generates over a billion different inverters before the identity or itself is reached again. As an example the 240-state inverters inv249start=[132 149 180 44 218 3 25 209 63 184 90 225 105 9 142 76 157 27 17 170 210 167 166 190 50 31 72 7 239 15 40 24 11 130 23 152 185 20 32 49 35 101 56 232 141 133 120 28 161 78 83 182 197 70 91 116 109 100 113 183 204 47 179 222 58 178 220 173 151 53 118 192 140 48 43 159 84 186 148 206 81 26 156 202 195 55 235 39 5 57 4 45 187 117 112 143 207 54 61 60 234 73 212 80 223 171 121 177 87 219 51 103 224 147 176 97 163 136 10 217 115 196 96 237 129 233 201 134 194 213 104 125 199 79 16 85 162 22 52 34 139 30 189 12 221 122 227 128 106 153 229 200 102 92 111 181 160 93 169 36 88 127 124 193 203 98 65 138 146 144 135 188 74 205 33 14 191 38 75 231 226 137 68 94 8 2 172 228 82 41 108 131 29 62 174 13 21 158 236 164 154 230 214 165 95 211 238 99 216 168 215 69 37 46 77 67 175 71 1 145 114 198 155 19 18 123 59 42 89 107 6 66 208 150 240 64 119 86 110 126] using invkb=invkstart(invkb) achieves over a billion results before the starting inverter is reached again. This does not always mean that all generated inverters are different, as this method has some shorter internal branches. This means that there may be shorter series of inverters generated if one starts with a different inverter in the sequence. That is, once a sequence as above is found one may execute invkb=invkstart(invkb) but with invkb as start being a later inverter generated but still using invkstart to modify.

However, in most cases one can easily check that at least over 10 million up to over 1 billion unique k-state inverters are generated. Practically, it may mean that one has to run a program that uses different starting inverters and checks if the starting inverter is reached after a preset cycle of for instance 3 billion. Most 240 state inverters run at least for 10s or 100s of millions generated different inverters before the starting inverter is generated again. This slows down the overall process. But experience shows that for n greater than 128 when running overnight always a 1 billion cyclic inverter is found. This was done in Matlab on a Windows 10 PC.

It seemed initially unlikely that so many different sequences of unique inverters are and can be generated. Closer examination of the relevant numbers shows why. It may appear that a series of 1 billion different inverters is quite large. But one should view that in the context of the large number of possible inverters. That number for n=128 is factorial of 128 which is about 3*10\hat{ }215. And while 1 billion (10\hat{ }9) is large, it is a mere spec if even that in such a large universe. And the chance to duplicate that is extremely small, to be close to non-existent.

The above is called self-generation or self-propagation of inverters herein. One way to find a set of a large number of generated inverters is by randomly generating starting sets, for instance by using in Matlab inv240start=randperm(240) for k=240 and invkstart=randperm(k) for other values of k. For the k=240 the inventor applied a loop of 50 trials and stopped a trial loop once a newly generated inverter invknew==identity or invknew=invkstart. All loops generated at least 2 million different 240-state inverters. In order to find the invkstart starter or seed or seeding inverter that generated the most within the check conditions, a maximum counter was maintained and only the starting inverter with the highest count was maintained and saved, for this example. The result on a standard Windows computer was generated within about 20 minutes. One may also set a minimum condition like tel==100,000,000 and let the test program run until it finds a fitting 240-state inverter. Also, this worked fairly easily as indicated earlier.

A similar approach may be taken for an 8*240=1920-state inverter by applying bitwise shuffling and/or for k=256 byte-wise inversion. This is change upon change. And one may apply the modification to one or more or to all rounds.

For instance, using plaintext=‘I like to read! I like to read! I like to read! I like to read! I like to read! I like to read!’ has a size of 6 blocks of 16 bytes. When the inv240start is identity, no Expanded Key array is shuffled and the generated ciphertext is Ci=‘6deb6e66165c0f8d85369bb6d2051d4ca7f25733d8432306e112413bff4a2a5281d091 4fac2e0d74dc6ef7568213beaa2da18f7192baa17cb2d07ae8181235bfb554d06d82430ba67e7e 7fba4c0057ef729751575bf845a78edfbOccd6ebe4’ in bytes.

A Matlab program decrypts and validates it correctly. Using an earlier above provided self-generating or self-propagating inv240start, creates ciphertext C=‘8905a95771f059021f7924475be4b029ca832276c4f7f8b074007fecca69c4d4ab4ela2108 5a4c282fce8b537eb1b31a080b3237a3e2c3ae40034d7ccbecc6842c77ac50388d3f67191a d085cfb1fd5530184d8811e61c90a4ae7f7e70df76’. This is different from the original ciphertext, but equally random. Furthermore, the modified Matlab program correctly decrypts and validates.

For review purposes the inventor also printed intermediate results. These show that for each block a new and different inverter was generated created a novel and modified Expanded Key array. One may shuffle the original Key Expansion array or one may shuffle a previously shuffled Key Expansion block. One may also apply the shuffled Key Expansion block for one or more rounds, for instance for applying it as a shuffled Key array for a AddRoundKey( ) operation. And one may use multiple shuffles and/or inversions for modification. However, the state array is only 128 bits and may not be large enough for self-propagating inverters. One may use 4 bits words for shuffling, but this brings the 128 bit only to a 32 element sequence and thus 32-state inverter. It will still change the state array, especially when combined with a 256-state inversion. The effect of modifying the original Key Expansion array and using a corresponding key array therein for AddRoundKey( ) is an effective way to selectively modify over a very large range of modifications of the Key Expansion array. One may maintain the original Key Expansion array for one group of unchanged rounds and the modified Key Expansion array for one or more selected rounds.

One may also apply the shuffle and/or shuffles and/or inversions on the State Array in a round or in multiple rounds. Or in any appropriate data transformation, for instance on the S-box in AES.

One may leverage combinatorial explosion in self-propagation by using a p-state seed reversible inverter with p>n or p>>n, self propagate a new p-state inverter and (for origin-1 for instance) remove all elements >n from the p-state inverter, which will leave an n-state reversible inverter. For instance inv9=[2 6 1 9 7 3 5 4 8] with all element >5 removed leaves inv5=[2 1 3 5 4], a 5-state reversible inverter. This is one way to ensure large cycled self propagation. Herein one benefits from combinatorial explosion. For instance, one may apply a 500-state reversible seed inverter and use it to generate self propagated follow up inverters, and reduce each 500-state inverter to an effective 256-state inverter by removing excess elements >256 in origin-1, as an illustrative example.

Another way to ensure self propagation in a large possible way is to apply lexicographical permutation starting from the seed inverter. For instance, Knuth's Algorithm works well. While it works in a systematic way, the results are unpredictable because the seed is secret. Others include Myrvold-Ruskey Algorithm and Myrvold-Ruskey Algorithm, for instance. Assuming that the seed inverter is secure or secret, the follow on permutations are also secret. A setback may be that a single step permutation does not create sufficient change. In that case one may divide an n-state inverter, for instance, in p parts of k n-state elements and permutate the parts based on a pre-agreed rule and then re-assemble the permutated parts again into an n-state reversible inverter.

One may apply a similar method of shuffling and/or inversion to all or part of the ChaCha20 encryption method. For instance, in ChaCha20 as defined in for instance RFC 7539 which is assumed to be known to one of ordinary skill, the state array is a 4 by 4 array of words of 32-bits. The second and third row of the state array are formed from a 256-bit key. For each block of plaintext that is to be encrypted the same input state array is applied, except for a counter word which is updated for each block. One may shuffle or invert any word of withs or series of words as desired by the aspects of the present invention, disclosed above herein. Considering the possible variations, it seems worthwhile to shuffle at least 128 bits or perhaps a row or a column of a ChaCha20 state array. As in AES-GCM, the state array is used to generate a keystream and needs not to be reversed. If one doesn't want to change the binary distribution of bits in a state array one may stick to shuffling.

One may apply the inversion, and/or shuffling and/or FLT on a block of a message that is encrypted and also on a packet of a Virtual Private Network (VPN) and of course on each of a plurality of messages in a (seemingly continual) exchange of data by multiple messages. One may also update the n-state inverter for each block in the manner of a self-propagating n-state inverter. For ChaCha20 and its variants, one may also n-state invert more than only the counter as described above. One may invert one or more of the nonces or of the constants or even the key. As long this is done in a repeatable and agreed upon way, one may apply it in both encryption and decryption.

The above shuffling and/or inversion methods also apply to hashing such as SHA-256/SHA-512 and SHA-3 and SHAKE and others. Certainly, SHAKE and SHA-3 use large state arrays and several rounds (24 in SHA-3). SHA-256 operates on blocks of 512 bits and SHA-512 on blocks of 1024 bits which may be inverted and/or shuffled in one or more rounds and other modifications as disclosed above. Similarly, one may shuffle/invert the 256 bit output of SHA-256 and the 512 bit of SHA-512. This creates private or customized hashing. A similar modification may be applied to known signature methods in data exchange or to internal sequences or data series or blocks or words or bits that are processed.

Encryption, decryption and hashing are all used in different computer applications that require security and include: data transmission and data storage, for instance in

Cloud based applications and data storage. It may be applied in VPN as already indicated. In credit card security. In Network Security Protocols. In authentication protocols. In Bluetooth and other wireless communications. In cellular phone communication. In WiFi communication. In scanning apparatus. In file sharing. In end-to-end encryption. In signal distribution. In data distribution such as updating data and/or programs. Computer based cryptographic methods are applied so ubiquitous as impossible to list all individually. In this AES and SHA (both old SHA and newer SHA-3 and variants thereof) are the dominant applications with ChaCha20 and its variants also widely applied. These all may be modified with aspects of the present invention as described herein.

The above applies to direct modification or transformation of data. It may also be applied to functional transformation. For instance, one may apply the self-propagating inverters to the inverters that are applied to an FLT as illustrated in FIG. 1. This means that one may FLT the functions in for instance AES and/or ChaCha20 and/or hashing such as SHA-256 and SHA-512 and/or SHA-3 in a virtually infinite (well billions) number of instances of modified cryptographic primitives. In fact, every modification that applies the FLT may be supported by such self-propagating inverters.

The inventor teaches and discloses in U.S. patent Ser. No. 18/908,321 (the “321 application”) to Peter Lablans filed on Oct. 7, 2024 which is incorporated herein by reference, a computational function transformation by including and/or modifying an n-state carry generating function, which is preferably random-like in appearance. To briefly re-explain how that works the example of byte-wise XORing as applied in AddRoundKey( ) in AES-CTR and/or AES-GCM and/or ChaCha20 will be used. That example is used because it uses a one-way repeatable approach for generating a key-stream. But its application in hashing is also one-way. For instance, the AES part in AES CTR/GCM is used to generate a keystream applied both in encryption and decryption. The inventor recognized that this allows the use of one-way functions in AES, which otherwise are reversible operations. AddRoundKey is an example of that. In fact, AddRoundKey is an involution as both encryption and decryption applies the same functionality.

AddRoundKey( ) in AES as set in FIPS-197 is a bitwise XORing of words of bits in a 4 by 4 byte array in the Key Expansion array and the 4 by 4 byte State Array, as one of ordinary skill in cryptography knows. FIPS recommends XORing corresponding columns in the two arrays. Whether it is done by rows or columns doesn't matter as the XORing is a carry-less bitwise operation. The inventor gave it a unique twist by considering the byte-wise XORing as being represented by an addition over GF (2\hat{ }8=256). The 321 application then does a computational function transformation, by transforming for instance the addition over GF(256) of 4 256-state elements (the 4 bytes in a column of an array) as a radix-256 carry propagating operation. The radix-256 aspect indicates that the addition (like a carry ripple addition) has a repeat of two parts: 1) generate a 256-state residue of 256-state elements in augend and addend, followed by determining carry elements, and creating a new residue until no more carry elements are propagated. This causes the carry to ripple through the partial sums, hence the name carry ripple addition.

The 321 application applies a completely random or random-like carry function, which may in the 256-state case be a 256 by 256 256-state lookup table, wherein the elements may be any of 256 states. This is of course different from the standard carry ripple adder wherein the carry is only 0 or 1 (when working in origin-0). The 321 application explains that this approach does not change the distribution of the outcome sum, which remains flat or uniform over all possible outcomes when using all possible input operands. This is called a flat or uniform sum-space. The only requirement is that the residue function absolutely must be an n-state reversible function.

There is an immense number of possible outcomes. In accordance with an aspect of the present invention one may apply any n-state carry function in a radix-n addition and still maintain a uniform sum=space of the modified radix-n addition as long as the n-state residue function is reversible. Expressed in possible n-state n by n carry table one gets the astonishing number of (n\hat{ }(n\hat{ }2)) different carry functions. For n=256 this is beyond astronomical 10\hat{ }150,000 different tables. These include of course minimally modified tables. Practically one may expect the still astonishingly large number of 10\hat{ }1500 different 256-state carry function tables. Practically one may start with a pre-stored 256 by 256 256-state carry table that may be randomly generated and transform dynamically with either a 256-state inverter or a 65536-state inverter shuffle or an FLT.

While one may keep using the carry propagating addition of 4 bytes (like the columns of the state array) one may expand it to 2 columns or 8 256-state elements or even addition of 16 256-state elements. Furthermore, one may apply this function transformation to all rounds or a single round or 2 or more rounds. One may apply different carry tables if one desires.

A practical issue may be to store different 256 by 256 state 256-state lookup tables. Such a table has 256*256 or 65536 256-state elements. In accordance with an aspect of the present invention, one or more self-propagating inverters are used to generate different carry tables. An original table may be stored as well as self-propagating inverters. The self-propagating inverter may be a 256-state inverter, which inverts the elements of the carry lookup table. The lookup table may be represented as a one dimensional array and shuffled. One may shuffle all the elements of the table with a 65536-state inverter or just parts of the array. One may also use techniques like using different state elements by using different word sizes as explained above. One may apply one n-state self-propagating inverter which preferably generates billions of unique inverters and use that to extract smaller state inverters. Or one may use 2 or more different self-propagating inverters to perform the modifications.

One may use the generated different inverters also as required elements in an FLT of an n-state operation. This may include the word-based XORing or any mod-n addition or n-state operation that is FLTed. These examples are the simplest to follow for illustrative purposes.

It was already explained that one may use self-propagating inverters to perform the element inversion and/or shuffling. This prevents the need to store massive numbers of inverters for encryption of plaintext that has many blocks. For each block one may apply an inverter that is generated from the base inverter in a self-propagating chain. This has further benefits, as one may re-use these inverters by applying a different starting point. This creates different inverters for blocks of plaintext that are in identical block positions.

Preferably, one applies stored n-state base inverters that are used as self-propagating inverters. One may also generate n-state inverters that are derived from the secret parameters of encryption such as the key in AES and ChaCha20 and other encryption and hashing methods

A difference between keys and n-state inverters is that 1) keys and n-state inverters may have different sizes, even in bit representation; and 2) a key, even of same size may have certain n-state elements more than once appearing or even not appearing at all in the key. In an n-state reversible inverter all n-state elements appear exactly once. A first step to create an n-state reversible inverter from a smaller n-state sequence in accordance with an aspect of the present invention, is to expand an existing or computed key to the required size commensurate with the n-state reversible inverter. There are many secure algorithms that do that. One way is using a hash like SHA-512 and do a repeat hash on generated hash and concatenate all hashes until the desired length is obtained. For instance, 8 SHA512 hashes will generate 8*32 bytes in concatenated hashes which represents 256 256-state elements.

In accordance with an aspect of the present invention, a hexadecimal sequence of 256 bytes is converted into a sequence of 256 256-state elements. One then organizes the sequence in two representations such as arrays. A first array with rows with row index k starting with the corresponding 256-state elements followed by all positions that it occurs. So when the element 33 occurs 4 times in positions 4, 19, 101 and 233 it shows [33 4 19 101 233 000000] (Matlab does this simply with the ‘find’ instruction). For convenience the related element 33 is shown in position 1. The 0 indicating not occurring. So element 154 which doesn't occur at all has [154 0000000000], with again the element itself showing in position 1. Also, a second array or sequence of elements that do not occur in the expanded sequence is created. The inventor created a Matlab program that goes through the arrays in the following way: it selects the first element that does not occur from the second array and goes to the first row in the first array that shows more than 1 occurrence of an element and replaces the second (or later the ‘next’) occurrence with the non-occurring element. After replacement the replaced position itself is replaced with a blocking code that indicates that the position is no longer available for replacement. The program thus works itself through the list of non-occurring elements in the second array, until all multiple occurrences beyond once are replaced with previously non-occurring elements. The inventor implemented this in Matlab. One can make several variations of the above, all with satisfactory results.

This works well as demonstrated by the following for a 25-state sequence:
seq25=[23 9 24 24 15 3 10 7 7 6 1 23 12 15 8 25 25 25 17 19 9 14 7 18 20]

The Matlab procedure named inv25=createReversibleInverter (seq25, 25), then creates inv25=[23 9 24 16 15 3 10 7 2 6 1 13 12 11 8 25 21 22 17 19 5 14 4 18 20].

Comparing the two (seq25 and inv25) shows how it works. One may modify the order, for instance always changing the first element in duplicates and maintaining the second occurrence. Other are possible and fully contemplated. One may check the correctness in Matab by doing a sort (inv25) which should be an identity. For very large sequences, such as n=256 or longer, one can check by generating test=1: n and then doing isequal (test,sort(invn)).

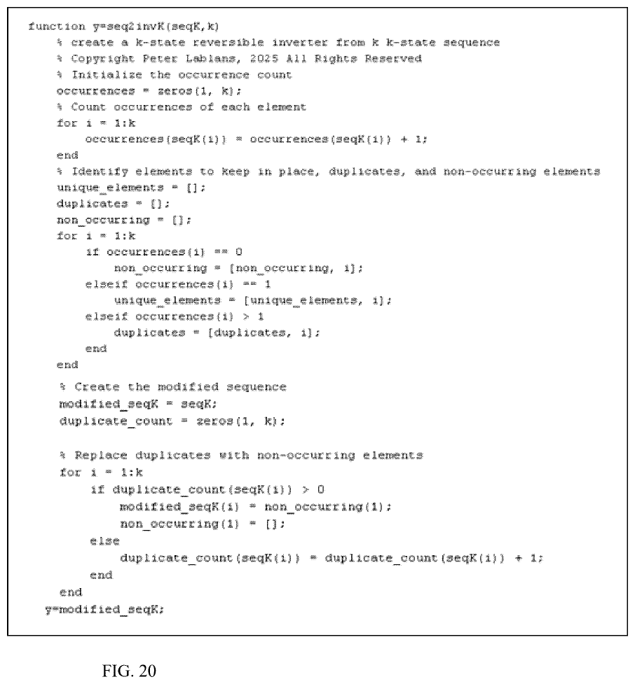

A program that extracts or generates a reversible k-state inverter from a random k-state sequence of k elements is shown in FIG. 20 as a screenshot of a Matlab program instructions. One aspect of this program is to maintain the first unique occurrence. One may change that in different ways, including adding a constant a mod-k to all unique elements and restart the procedure.

There are many different ways to generate k-state reversible inverters from a sequence of k-state elements in which elements occur more than once. The program of FIG. 20 is an illustrative example. One may generate different k-state reversible inverters from the same sequence of k-state elements. One may start replacing duplicates from the back of the sequence, moving forward. One may remove from the sequence of n-state elements all duplicates and create a sequence of k unique n-state elements, and determine the missing n-state elements. One may insert the missing n-state elements for instance from the back of the sequence of k n-state elements and insert the missing elements ordered in an ascending way, by interleaving a missing element between two unique n-state elements. As example. assume that one has a 16-state sequence with elements 3, 7, 11 and 15 missing. This creates a reduced sequence of 12 16-state elements for instance inv16r−[14 8 9 10 6 2 1:5 13 12 4 16]. Inserting {3,7, 11, 15} in ascending manner from the back in interleaved fashion creates” inv16recon=[14 8 9 10 6 2 1 5 15 13 11 12 7 4 3 16] to create a reversible 16-state inverter. One may change the size of intervening steps between interleaving the order of insertion and many more different and possible steps to get from an n-state sequence with duplicate elements to a reversible n-state inverter.

No matter what one applies: one constructs an n-state reversible inverter from a sequence that may be interpreted as a sequence of at least n n-state elements with duplicates. Furthermore, by sequence expansion as described herein, one creates a sequence equivalent to at least n n-state elements from a sequence equivalent to k n-state elements with k being smaller than n. For instance, one uses a shared secret PKI key of 32 bytes to be expanded in a pre-agreed way to a secret sequence of at least 256 bytes most likely with duplicate 256-state elements and modifies it with an agreed method to a reversible 256-state inverter. So different machines, constructing a secret and secure shared PKI key are enabled to construct a secure and secret shared n-state inverter.

For convenience the above method was based on PQ secure PKI like Kyber which generates a 32 byte key. Older PKI methods like Diffie-Hellman, RSA and others may create a secure key that is larger than 256 bytes, or sometimes exactly 256-bytes. For instance, using 2048 bit keys provides the exact required length of 256 bytes and one may skip the expansion step. Or one may create a base 4096 bit key. And instead of sequence expansion one has to perform sequence reduction. Sequence reduction may be as simple as just using the 256 byte equivalence part of the large sequence. For instance, use the first 2048 bit of a 4096 bit sequence. Or the equivalent last part. Or provide a sampling rule. Once one has a sequence of the right size, one may apply a duplicate removal/replacement rule. Or one may change the order of steps, That is in a 4096 bit sequence create a byte wise representation (as illustrative example) remove all duplicates. If lucky, one is left exactly with a 256-state reversible inverter. If not one has to apply an approach as illustrated earlier herein.

A method of replacing duplicate n-state elements in a sequence of n n-state elements with non-occurring n-state elements is illustrated in FIG. 29. FIG. 29 is a flow diagram that reflects the instruction flow of a transformation of a sequence of n n-state elements that is not an n-state reversible inverter to an n-state reversible inverter. An actual executable Matlab program that performs such transformation is shown in screenshot in FIG. 20.

One may use the Key Expansion or Key Schedule of AES as a separate module to expand a key to a sequence of a desired size. Standard in AES-GCM, a key is expanded from k=16 to k=240 bytes. By resetting the for-loop in the key expansion one may be programmed to generate 256 (instead of 240) bytes.

One may apply one of different well known expansion methods, including cryptographic key expansion, Feedback Shift Register applications, and Key Derivation Functions (KDFs) such as PBKDF2, HKDF, bcrypt, scrypt. Which may be modified to fit a required sequence length or may itself include transformations like FLT to make outputs less predictable.

The inventor applied the above process to generate a key based 256-state sequence of 240 bytes that is converted by a program into a 240-state reversible inverter that may be used to shuffle the elements. Herein the extracted 240-state inverter may be applied as a self-propagating inverter. One may also extend the key schedule to expand to generate 256 bytes. The thus generated sequence may be used in a similar way to create a reversible 256-state inverter, which may be used in an FLT or other inversions as described herein. It may also be applied as the base in a self-propagating 256-state inverter.

In accordance with another aspect of the present invention, a k-state reversible inverter is generated from a k-state Feedback Shift Register (FSR), which is preferably a maximum length shift register. (MK-FSR). For instance, one may use Magma Calculator to determine a ML-FSR of 16-state elements. One such FSR may be determined by primitive polynomial x\hat{ }4+14*x\hat{ }3+x\hat{ }2 +15* x+2. One may convert this into transition matrix gal65536=[1 1 1 3;2 1 1 16; 1 2 1 2;1 1 2 15] which is provided in related Matlab origin-1 format of the Galois configuration array of the FSR. One may then apply the property of the ML-FSR that all shift register contents are unique. One starts for instance with start=[1 2 3 4] (in origin-1 and runs vecn=gal65536*vecn for 65535 cycles, with vecn being initialized as start. It is well known that a k-state FSR with p shift register elements has k\hat{ }p-1 unique states. The missing state is the all zero state or [1 1 1 1] in Matlab. Thus one creates a sequence of 65536 unique words of 4 16-state elements by running the FSR for 65535 times and adding to the output words [1 1 1 1]. One can simply modify the words into their decimal representation this creating a sequence of 65536 unique numbers which is of course a 65536-state reversible inverter.

Different (shifted) sequences are created by using different start points. Furthermore, the inverters are modified by selecting different insertion points for the all-zero elements word. Furthermore, the ML-FSR may be modified by a base-state (b=16 in this case) reversible inverter to apply an FLT upon the ML-FSR. One may also apply a Fibonacci configuration for the ML-FSR.

Another method to generate a large k-state reversible inverter is to apply a much larger q-state ML-FSR and select k words of the possible words. For instance, one may use a 16-state ML-FSR with words of 6 16-state words. Using Magma Calculator one may determine a primitive polynomial of degree 6 over GF (16). One example of a Galois transition array generated in this manner creates gal2-[1 1 1 1 1 14;2 1 1 1 1 16;1 2 1 1 13; 1 1 2 1 1 2; 1 1 1 2 1 8; 1 1 1 1 2 12]. In one illustrative embodiment one may run vecn=gal2*vecn, wherein vecn is initiated as [1 2 3 4 5 6] and run the FSR for 65535 cycles and capture only the first 4 elements of vecn and convert into a 65536-state element and also insert the [1 1 1 1] equivalent element. This creates a sequence of 65536 elements, of which actually only 41,437 elements are unique. Call the thus generated sequence of 65536-state elements dec2 and do inv2=seq2invK (dec2,65536); as illustrated in instructions in FIG. 20. Testing this inv2 confirms that it is a 65536 reversible inverter but drastically different from the earlier generated 65536-state inverter. One may create different 65536-state inverters this way by extracting different 16-state elements from generated words.

To illustrate the results of using the FSR approach, the first 25 65536-state elements of the generated 65536-state reversible inverters will be provided. Just 25 because the whole inverter of course has 65536 elements which is not helpful to be displayed for such a large number. The ML-FSR using a register of 4 16-state elements generates ultimately inv65536a−[292 25124 25620 25713 1608 60185 16185 12923 32642 10471 50925 46251 30701 49083 30558 37040 54272 55243 29147 31676 21508 26482 10602 7170 11999 1]. And the 6 16-state element FSR after applying the inverter extraction: inv65536b=[292 50872 51919 45271 60561 28051 47780 36717 44297 46763 38441 44189 12918 64831 37522 46420 38424 21127 64306 59439 45817 36842 38333 12776 48997 1]. Both start, for obvious reasons of the starting state, with 292, but diverge after that.

One of ordinary skill will recognize that additional modifications can be made, including using different FSRs of different lengths, using FLTs, modifying the sequence-to-inverter conversion. All of this indicates the ability to generate an enormous number of k-state reversible inverters from a limited starting point. Furthermore, the thus generated k-state reversible inverters may be applied as self-propagating k-state inverters.

The use of generating a 65536-state inverter is to apply such an inverter to shuffle a 256-state 256 by 256 function or lookup table as a shuffled table. This is useful in the use of modifying a starting random carry table as disclosed earlier herein. It was determined that the sum-space of a radix-n equivalent addition with a random carry table still leaves the outcome or sum-space uniform. Not using a repeat or many repeats of a certain implementation heightens security of cryptography. Especially in multi-block encryption, almost all blocks are encrypted using the same encryption parameters with exception of an often predictable counter. It will increase security when one secretly and undetectably or at least securely modifies at least a single operation. Changing for instance the 256-state random carry function at least every 10 or 20 blocks, but preferably for encryption of each block, will dramatically increase security. However, it is not very efficient to store 100s or millions or more 256 by 256 random tables. Thus shuffling a base table with a random k-state inverter will create greater security without the need for storing a large number of tables.

Furthermore, it is not needed to change the same aspect for all blocks. As disclosed above, there are many ways to modify generated key-stream per block, such as function FLT in AddRoundKey and MixColumns ShiftRows and SubBytes, as well as modifying the key schedule generation, both by inversion as shuffling. And one may modify (reversibly) the XORing of plaintext with keystream. One may also shuffle and/or invert the elements of the state array. And one may change the specific round that one wants to modify. In that sense, one may modify particularly processing intensive functions or tables directly after execution and have a processor core transform the related data or function while other cores are processing other modifications, to achieve a wide array of one may call just-in-time (JIT) transformation. This JIT transformation achieves an almost continuous CFT without substantially slowing down the processing but achieving modifications on an astronomical scale, like a factor 10\hat{ }500 or greater, that is infeasible to detects and/or to successfully attack.

One application of a function transformation in digital signature generation and verification. Recently NIST released novel post-quantum standards, like NIST FIPS-203 entitled Module-Lattice-Based Key-Encapsulation Mechanism Standard called Kyber.

Kyber generates a key of size 32 bytes. In order to generate a k-state reversible inverter from a key or other sequence that is smaller than k one needs a key expansion application, generally known as a Key Derivation Function or KDF. Most KDFs apply a hash in repeat iterations to generate a longer sequence wherein the generated hashes are concatenated into a desired size. Among KDFs one may apply are bcrypt, HKDF (HMAC based), Argon2, scrypt, and/or PBKDF2, for instance. One may also use a hash like SHA-256 or SHA-512 or SHA-3 variations in sufficient iterations. Unfortunately, attackers are building enormous libraries or rainbow tables in order to crack hashes. One way to create a more secure expanded sequence is by varying expansion steps for parts of the expanded sequence. That is SHA-512 for a first series of 512 bits, followed by SHA-3 512 for the next 512 bits then again SHA-512 and so on.

Yet another way is to modify SHA-512 or SHA-256 in accordance with a transformation as disclosed earlier, for instance by FLT of the bitwise XOR function as applied in SHA or the mod-2\hat{ }32 addition, per FLT. One may use for each block generation a different inverter generated by a self-propagating inverter as explained herein. Such a varying generation method may be applied if one is not entirely sure about the security of an initial key.

Current Advanced Persistent Threat (APT) attacks, where attackers observe in-cloud users for long periods make it likely that all cryptography for that account in that specific server is compromised. That means that even Private Circuit cloud may not be secure. Furthermore, attacks one existing encryption are improving, while enormous libraries on key and other parameter libraries are probably being established. Unfortunately this means that the standard encryption that one relies on may not be as secure as assumed. Furthermore, the current Harvest Now Decrypt Later attacks indicate confidence by attackers that ciphertext can be broken in the future. This means that security has to be improved now, if one wants to be sure that harvested ciphertext will not be broken in the next decade. A burden of data security is increasingly shifted to the data owner. In that case, the data owner better provides the best protection for data on their own and not rely on (potentially at risk) standard encryption. The above novel methods disclosed provide significant additional protection that may protect encrypted data for at least the next 10-20 years.

There are different ways to activate the above security improvements. One way is to let all data leave a private network into the cloud or enter a private network from the cloud though a computer or network server behind a fire-wall. This server or computer may have pre-programmed the required parameters. One may create a coding scheme that determines what modification parameters are used and how they are applied, including initial settings, rounds to be affected. which function or multiple functions are transformed, derivation of expanded keys and inverters and the like. This may form a vector of numbers and/or codes that indicate a variation. For example a code of which a hash may be created indicates [5, 4, 9, 22, . . . ] and means using 5 iterations of a self-propagating inverter (code 5), to modify with FLT AddRoundKey bitwise XOR (code 4), in round 9. for block 22 in AES-GCM. The length of the code interpretation can be a vector of up to 100, 1000 or even 10000 meaningful elements. They may be managed by a Key Management System. For computers somewhat unknown connected via an application, one may share procedures using the codes but that may use PKI based key exchange to derive required parameters such as inverters from secure keys, as disclosed herein.

The herein taught modifications in general preserve an architecture of proven and well tested cryptographic devices and methods. They modify the implementation of such architecture in that the numerical output of the related transformed cryptographic operation is modified with a factor of change that may be an astronomical factor 10\hat{ }500 or greater. The modification, due to preserving the base architecture does not leak or reveal itself in the output such as plaintext or hash, which will preserve its statistically random character.

The herein disclosed modified and novel computer functionality is expressly used in cryptographic modification of data signals transmitted between at least 2 different computing devices. The cryptographic application may be an encryption, a decryption, a hashing, a digital signature generation and/or a digital signature verification. Data is processed in a first device and then in its processed form transmitted to a second device. This may be as simple as a local computer using a processor (the first device) with memory to create encrypted data or a hash, and transmit the encrypted data or the hash to a storage device like a hard disk or a flashdrive which may be removable. It may also be that the processed data (ciphertext and/or hash and/or signature) is transmitted via a network to a remote device such as a server or a receiving computer. A computing device may also receive processed data or retrieve data from another device and processes the received data to for instance decrypt encrypted data and/or re-computes a hash and compares it with a received hash and/or verifies a signature accompanying a digital file, or any other relevant cryptographic operation.

The cryptographic operations and devices as described herein provide security in data storage, reception and transmission between computing devices. Furthermore, the requirements of speed of exchange and the limited waiting time that is available, the devices and/or methods as taught herein work with a speed equivalent to processing at least 1000 bits per second and preferably much faster. There are several measurements known in the literature. For example, using hardware acceleration (such as Intel's AES-NI), AES-128 can achieve speeds of around 3 GB/s. This means that encrypting a typical internet packet (which is around 1,500 bytes) would take approximately 0.5 microseconds (0.0005 milliseconds). The required speed as well the requirement to transmit the cryptographic data between computing devices over a physical channel, preferably an electro-magnetic field enable channel, or even a quantum-mechanical enabled channel, requires processing speeds that cannot be achieved reasonably by any human or even multiple humans even when using paper and pencil. The herein disclosed and later claimed aspects of the present invention pertain strictly to machine or computer executed functionality.

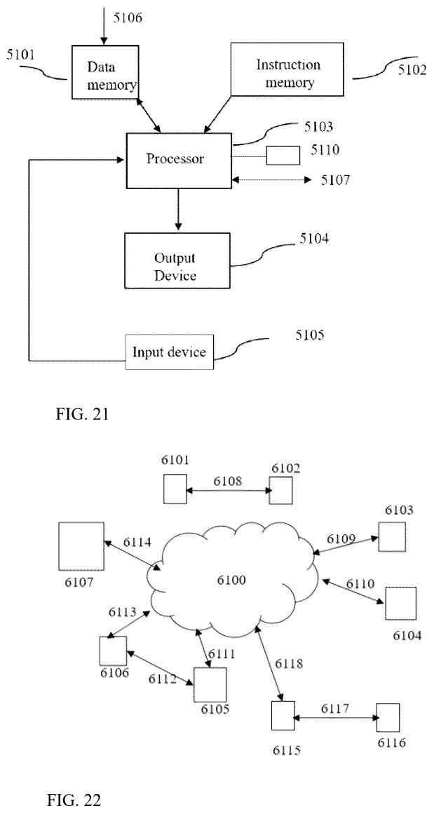

A computing system illustrated in FIG. 21 and as described herein is enabled for receiving, processing and generating data. The system is provided with data that can be stored on a memory 5101. Data may be obtained from a sensor or may be provided from a data source. Data may be provided on an input 5106. The processor is also provided or programmed with instructions executing the methods of the present invention is stored on a memory 5102 and is provided to the processor 5103, which executes the instructions of 5102 to process the data from 5101. A processor may be a programmable processor, it may also be a fixed program processor. A processor may have multiple processing cores. And while the processor is represented by a single box, it may be a combination of a CPU and one or more assists like a GPU or nowadays NPUs or neural processing units. Data, such as an image or any other signal resulting from the processor can be outputted on an output device 5104, which may be a display to display data or a loudspeaker to provide an acoustic signal. The processor also has a communication channel 5107 to receive external data from a communication device and to transmit data, for instance to an external device. The system in one embodiment of the present invention has an input device 5105, which may be a keyboard, a mouse, a touch pad or any other device that can generated data to be provided to processor 5103. The processor can be dedicated hardware. However, the processor can also be a CPU or any other computing device that can execute the instructions of 5102, including FPGAs and discrete components. The processor 5103 in some embodiments has integrated or connected to it communication circuitry 5110 with a customized physical interface. A customized interface may be a connector, an antenna, a reader or read/write interface or any other physical interface to transmit and/or receive signals to or from an external device. Accordingly, the system as illustrated in FIG. 21 provides a system for data processing resulting from a sensor or any other data source and is enabled to execute the steps of the methods as provided herein as an aspect of the present invention. This is a illustrative example of a computing system. One may also have a computing system that is a dedicated custom circuit with discrete components either of a circuit board or on an integrated circuit. The system may also be realized as a Field Programmable Gate Array or ASIC or any other circuit that performs computing capability.

A computing device or system often works in a network or interconnection. FIG. 22 illustrates a possible network configuration. FIG. 22 has a communication network 6100. Network 6100 may be a single network such as a wireless or wired network or a combination of networks such as the Internet. The network may be a switched network or a packet based network, a private network or a public network or a virtual private network or any other communication network that enables connection of 2 computing devices and of 3 or more computing devices. In one configuration two computing devices 6101 and 6102 with communication circuitry to transmit, receive or transmit/receive signals are provided. The communication circuitry of 6101 and 6102 can transmit signals over a channel 6108. The channel 6108 is identified as a double arrow. This indicates that the channel is bi-directional, but it does not necessarily mean that 6101 and 6102 do both have to transmit and receive, though they may. For instance 6101 is an opening device or a smartcard or any other transmitting device and 6102 is a computing device that is part of an access mechanism that is being activated by one or more signals from 6101. Device 6101 for instance has cryptographic circuitry that generates opening signals that have to be detected and decrypted by 6102. For that application wherein each device has the appropriate instructions and data stored to complete an authenticated transaction, like opening. In one embodiment of the present invention there is thus only one way transmission by 6101 and receiving of data by 6102. The channel is a direct channel, like a wireless or wired or Near Field Communication (NFC) channel, a USB connection, a Bluetooth connection or any other direct connection. For the transaction itself no other channel is required. The devices 6101 and 6102 may have other communication capabilities, such as equipment to connect to network 6100, but are not shown. Devices 6101 and 6102 have different modified n-state switching functions stored on local memory. These may be updated from time to time.

Devices 6101 and 6102 may also perform some mutual authentication or for instance key exchange. In that case 6108 is a dual use (send and receive) channel and the devices 6101 and 6102 both have send and receive equipment. The same applies to devices 6103, 6104, 6105, 6106, 6107 and 6115 and 6116 and communication channels 6109, 6110, 6117, 6118, 6111, 6112, 6113 and 6114.

In one embodiment of the present invention 6115 may be a gateway server and 6116 may represent one or more devices connected to the cloud through gateway server 6115 that may implement machine cryptography as disclosed herein.

Computing devices 6103 and 6104 communicate with each other via channels 6108 and 6110 via network 6100. Cryptographic n-state switching functions may be stored locally and may be provided by secure server 6107 which is connected to network 6100 via channel 6114.

Device 6115 and 6116 communicate directly via a channel 6117. Device 6115 is also able to communicate with secure server 6107 via channel 6114. Devices 6105 and 6106 can directly communicate with each other over channel 6112 and with server 6107 via 6100 over channels 6111 and 6113, respectively. As needed 6105 and 6106 can also communicate via 6111 and 6113 via network 6100. Any of the communication channels, even though illustrated by double sided arrows may be single direction as dictated by practical circumstances.

For instance, devices 6115 and 6116 communicate directly via 6112 to complete a transaction, such as withdrawing money from an ATM 6115 machine with a smartcard 6116 and 6115 uses 6118 for verification from 6107 via network 6100. Assume 6116 to be a chipcard or smartcard which is connected to 6115. During an established connection 6116 can be updated with additional or replacement modified n-state switching functions.

Computing devices can be mobile or fixed. For instance, 6103 and 6104 are two computing devices that are connected to the Internet, for instance 6103 is a computer, such as a PC, a smartphone, a tablet and 6104 for placing an order and 6104 is a server for processing the order. For instance, 6103 is a computing device which may be a server, a computer, a PC, a smartphone, a tablet, a processor and the like to monitor and/or control an IoT (Internet of Things) device 6104 with a processor such as a camera, a medical device, a security device such as a lock or fire monitor, a thermostat, an appliance, a vehicle or any other device.

Terms like hash, signature, ciphertext, plaintext and the like have been used herein. The purpose is to describe the role of the related data. But these are of course in the sense of computer technology messages or signals that are being transferred between computing devices generally connected through a network. However, data or messages may also be carried on a storage device, such as a memory stick, a hard drive, an optical drive a portable device such as a laptop or a smartphone or a tablet and transferred from these devices to another device. Machine cryptography as described herein is applied to protect security and/or authentication of messages, data and/or devices.

The article “a’ herein means “one or more” unless explicitly used to mean one (1). Without such an explicit designation “a” means one or more.

A memory herein is a technical device that stores data that may be retrieved from the memory by a processor. A memory may be permanent such as a Read Only Memory, a programmable memory a random-access memory, an addressable memory or any other device that is used to store data and retrieve data from. That includes devices that may also be named storage devices such as tape drives, magnetic disks and optical disks for instance.

Cryptography as applied herein is machine or computer implemented cryptography. It processes data into cryptographic data that may be captured and/or processed by unauthorized machines or computers. The size of data, such as messages or files, is such that processing by hand of this data with required speed and volume, even with many people even with using paper and pencil is practically impossible. For instance, one may require a processing speed of at least 100,000 8-bit equivalent symbols per second. Furthermore, the herein described cryptographic methods make it infeasible to effectively and successfully recover the hidden information from transmitted data within at least 100 hours of computer based attacks. The herein disclosed methods and devices ensure security of transmitted data and/or validates the origin of the cryptographic data.

Disclosed herein are novel Computational Function Transformations (CFT) in Computer Implemented Cryptography. Classical and basically secure cryptographic methods and devices are analyzed and certain computational functions are transformed thus generating unpredictable results that make the generated output more secure. The CFT may apply to a function that retains its meta-properties, or sequences of data internally are modified completely or largely retaining statistical properties. One may increase security of standard cryptographic methods and protect against future breaking of cryptographic data by for instance quantum computers and protect data against theft of parameters such as keywords. One may also apply the CFT to diminish sizes of parameters while maintain if not increasing overall security. CFT therefore is useful as it increases security of data transfer over the Internet and/or storage of confidential data in Cloud servers at minimal increase in complexity and may protect unauthorized access to data for at least 20 years as brute force attacks, based on complexity of brute force attacks, will not be successful with all currently available computer power in the world during the expected lifetime of the universe.

The modifications provided herein apply what are called n-state reversible inverters herein. A reversible n-state inverter is a sequence of n different n-state elements. For convenience of display and processing, the n-state data elements in an n-state reversible are represented as being selected from a set of consecutive integers or natural numbers such as {1,2, . . . , n} or [0,1, 2, . . . , n−1}. This is for representation and other schemes in representation may be applied. An n-state reversible n-state inverter has a reversing n-state inverter with the combination of n-state reversible inverter and reversing inverter being identity.

The FLT as illustrated in FIG. 1 requires an n-state reversible inverter and its reversing inverter to create a modified version of an n-state operation that has different n-state outputs than the original unmodified n-state function, but maintains its meta-properties. Such meta-properties may be finite field properties. For cryptographic purposes, a preserved output distribution is of significance as it prevents creating a bias towards a certain output. For instance, in hashing operations such as SHA 256/512 and SHA3 and Blake and others, the steps of the work or data flow are such that the output of the hash, the hash value or hash, seems completely random. By a bias-free modification/transformation the bias free random appearance is maintained.

A hash is a one-way operation that is preferably NOT reversible. So, while for instance the addition mod-2\hat{ }32 as used in SHA256/512 is a reversible operation, one needs not replace it with a reversible operation, but preferably preserve its uniform or flat sum-space distribution under assumption of all possible input combinations.

Cryptographic hashing is used in many applications, including but not limited to: Digital Signatures: Widely used in RSA, ECDSA, and EdDSA schemes; TLS/SSL: Integral to certificate validation and handshake integrity; Blockchain: Bitcoin uses SHA-256 for block hashing and mining; Ethereum uses SHA-3 (Keccak); Password Hashing: Sometimes used (though not ideal alone); often combined with salting and key stretching.

Software Integrity: Verifying file downloads, firmware updates, and package signatures. HMAC: Used in HMAC-SHA256 for message authentication in APIs and secure communications. SHA-3 (Keccak) Post-Quantum Cryptography: Considered more resilient due to sponge construction. Ethereum: Uses Keccak-256 (a variant of SHA-3) for address generation and smart contract hashing. Digital Signatures: Supported in newer schemes like SPHINCS+and LMS. Secure Hashing in Hardware: Increasingly adopted in embedded systems and FIPS 202-compliant devices. BLAKE/BLAKE2/BLAKE3 File and Data Integrity: BLAKE2 is used in tools like Zstandard and Argon2 (password hashing). Cryptographic Libraries: Supported in libsodium, RustCrypto, and other modern libraries. Blockchain Projects: Some altcoins (e.g., Decred) use BLAKE-256 for mining. Password Hashing: BLAKE2 is used in Argon2, the winner of the Password Hashing Competition. High-Speed Applications: BLAKE3 is optimized for parallelism and used in performance-critical hashing.

One may compare the modifications with but differentiate it from stateful and stateless hashing as currently recommended and/or used. Stateful Hashing: Key, nonce, or other inputs evolve over time or between sessions. Maintains context or “memory” between operations, often requiring synchronization. Common in scenarios like: Merkle trees with sequential updates. Hash chains in password storage or one-time authentication tokens. Systems where per-message uniqueness is enforced (e.g. blockchains or voting protocols). It has higher entropy, more adaptive security, but requires careful tracking and may be vulnerable to state desynchronization. Stateless Hashing: Every invocation is functionally identical—same inputs, same output, regardless of time or context. Standard in SHA-2, SHA-3, BLAKE, etc. Customization (like a nonce or salt) must be explicitly included in the input data. It has simplicity, composability, easy verification, but is vulnerable to structural patterning unless external entropy is injected.

There are many digital signature methods for instance that may use different schemes for digital signature generation and verification. And more variants are added, like Dilithium and Sphincs+. While Sphincs+ originally recommended SHA-256 one is now recommended SHAKE-256 (which is a Keccack configuration).

SHA-2 as disclosed in NIST FIPS 180-4 Secure Hash Standard (SHS), 2015. It includes SHA-256 and SHA-512. SHS discloses the binary 2 operand functions that operate of words of w bits with w commonly being 32. Another function that is applied in SHS is addition mod-2\hat{ }w. Composite functions in SHS are Ch(x, y, z)=(x\hat{ }y)⊕(¬x\hat{ }z); Parity(x, y, z)=x⊕y (z; Maj(x, y, z)=(x/y)+(x\hat{ }z)⊕(y\hat{ }z); Parity (x, y, z)=x⊕y⊕z. Another function that is applied may be represented as: ROTR 28 (x)⊕ROTR 34(x) ⊕ROTR 39(x), which is a rotation right of bits in words and XORing of these rotated words. Furthermore, in an initial (pre-processing) stage, an XORing with pre-set constants is applied. Furthermore, addition mod-2\hat{ }w is widely applied.

It may not be necessary to change all functions and all constants in all rounds. In fact, as SHA-256 has 80 rounds selectively changing these aspects in one or more rounds may have dramatic effects and by their sparse application (for instance 1 in 80 rounds) are much more difficult to predict or isolate, while the avalanche effect takes care of rapidly propagating changes into the generated hash. The following are some aspects that may be transformed in SHS: 1) Field-Level Arithmetic Modifications including substituting bitwise XOR/addition with reversible functions over finite fields, and modifying byte-level operations independently or compositionally. 2) Modular Addition Substitution, replacing addition modulo 2\hat{ }w with a computationally statistical equivalent but altered version (e.g., permutation-based adder). 3) Constants Modification, permute, replace, invert, or encode constants using secret or keyed transformations. Randomize constants per instance to produce polymorphic variants. 4) Boolean Function Rewriting, redefining operations like Ch, Maj, Σ0, Σ1 with functionally equivalent but syntactically modified variants. 5) Selective round-based substitution or dynamic morphing per hash invocation. 6) State Initialization and Scheduling Variants, Rewriting the message schedule logic or bit-mixing step. Tweaking state initialization values. 7) Structural and Topological Transformations, Changing the round permutation order, iteration depth, or compression layering. 8) Contextual Control Key-based, nonce-based, or external-parameter-driven transformation selection. 9) Controlled randomness to induce instance-specific obfuscation. and 10) Execution Environment Coupling, Binding transformation logic to runtime or hardware fingerprinting data (e.g., trusted computing base, memory layout, etc.)

One may be concerned about processing 32-bit words and how to invert a 2\hat{ }32-state element or create a 2\hat{ }32-state reversible inverter. A simple, consistent approach is to split a 32-bit word in 4 8-bit words or the 64-bit word in SHA-512 in 8 8-bit bytes. Instead of performing the XOR one then applies an addition over GF(256) to each pair of corresponding bytes in a word of 32 or 64 bit, respectively. One may apply the same FLTed or 256-state inverter modified addition for each combination of bytes or 256-state elements. If one desires one may use 2 or up to 4 in 32-bit or up to 8 in 64-bit word operations.

For convenience and consistency, one may divide a sequence or 32 or 64 or any number of bits in equal sized sub-words. That is not a requirement for cryptographic purposes as the FLT maintains the inherent statistical distribution of operation outcomes. One may divide a 32-bit word into 1 word of 7 bits, one word of 9 bits, one word of 10 bits and one word of 6 bits. The smaller number of variations associated with smaller words is offset dramatically by the increased number of variations in the larger numbers, especially because different numbers of bits require different FLTs.

One may use “rule based” inverters. For instance, inv(x)=a*x+b mod-n is such a rule based inverter that may be applied for individual inversions as well as for individual reversing inversions. These rules, while useful, are also somewhat predictable and an attacker with large processing capacity may try brute force. One effective method is to use an n-state maximum length (ML) Feedback Shift Register (FSR) as described in U.S. patent application Ser. No. 18/741,663 to Peter Lablans, filed on Jul. 20, 2024, entitled N-state Maximum Length-Feedback Shift Register (ML-FSR) Based Cryptographic Machines, which is incorporated herein by reference. The implementation as an p k-state FSR with p k-state register elements and k-state feedback functions make it very effective, fast and configurable. The ML-FSR with an initial content is run for q cycles, creating a new FSR content which is the inverted element. By constructing a reversing FSR one can recover the original content by running the reversing FSR also for q cycles. The content in bits is p*k. A 32-bit reversible inverter may be constructed from an 256-state FSR having 4 256-state (8 bits) shift register elements. The number of different ML-FSR states in that case is of course 256\hat{ }4-1, with the zero-state being processed onto itself. It is shown in the patent application that one can FLT the ML-FSR based on a 256-state reversible inverter, which makes brute force attacks on that type of inversion infeasible.

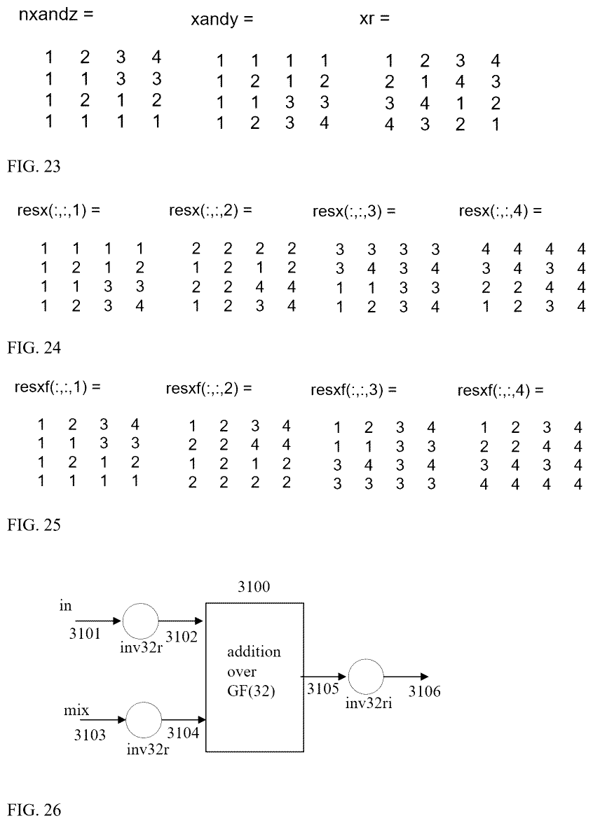

A special case may be the composite function in SHA-2 like Ch(x,y,z). As an example Ch(x, y, z)=(x\hat{ }y)⊕(¬x\hat{ }z) is FLTed. This function appears special because of its mixing of different binary function and its use of the standard NOT function. A benefit of the composite function is that for uniform distribution of the inputs the outputs are also uniformly distributed and no bias occurs. One way to approach the FLT is by using a lookup table. As an overseeable illustration let's take n=4. FIG. 23 shows the 4-state lookup tables nxandz for (¬x\hat{ }z); xandy for (x\hat{ }y) and xr for ⊕ for n=4. These tables are generated in Matlab and apply origin-1 for indexing, thus using elements 1,2,3 and 4 instead 0, 1, 2,3 in origin-0. For computational purposes that makes no difference as machine computations works on distinguishable states and not on the labels that human apply to it.

FIG. 24 shows the 4 tables in the 4 by 4 by 4 table resx(x,y,z) reflecting the expression Ch(x,y,z) for n=4. By FLTing each of the 4-state functions with a 4-state reversible inverter one may generate the FLTed table resxf (x,y,z) as illustrated in FIG. 25. The applied inverter is inv4−[4 3 2 1]. (again in Matlab origin-1). The benefit of this approach is that the distribution of states over resx and resxf is uniform with no bias.

One can make an additional transformational step, by executing-x over words of bits as a separate n-state inverter. This will create an even wider variation compared with the standard expression as in SHA-2 and SHS. However, the distribution of elements is no longer uniform. By applying this in only one round may further mix up the results and the bias, most likely, when applied in an early round probably is diffused by the avalanche effect. One may also apply different n-state inverters to FLT the individual functions. This will create different Ch(x,y,z) functions but with considerable bias, which, when applied in early rounds may dissipate.

The above related to for instance SHS and popular SHA-256 and SHA-512, which is rich in functionality that may be FLTed or otherwise (radix-n) transformed and data input and output that may be transformed. A novel hashing is SHA-3 (or Keccak) as disclosed and described in NIST FIPS 202 entitled “SHA-3 Standard: Permutation-Based Hash and Extendable-Output Functions”. SHA-3 is mainly a permutation based hashing process, with some functions. The XOR is applied to absorbing into and squeezing of data out of the processing stream. The XOR is uses as a parity computation but on a bit level. And a composite function is applied to algorithm 4 in section 3.2.4 of the SHA-3 spec.

In SHA-3 a state array A is defined as 1600 bits sequence arranged in a 5 by 5 by 64 array. This array is processed in several steps in several rounds (like 24 rounds) as taught in FIPS 202. In accordance with an aspect of the present invention one may modify all or part of the 1600 bits with an n-state inverter with n greater than 2 and preferably 5 or greater. One may invert elements of the 1600 bits, for instance as bytes, with a 256-state inverter. One may invert parts of the 1600 bits, for instance as lanes of 64 bits or 8 bytes or as modified rows or columns in slices of the array. One may also invert a word of 5 bits or invert all the bits in a slice as a set of 5 5-bits words with a 5-state inverter or invert a 25-bit word with a 2\hat{ }25-state inverter. Or invert any series of bits in the state A by an n-state inverter. Preferably one performs the modification in an early round of total rounds, preferably in a round before the ¾ mark is reached and more preferably before 50% of the rounds is reached. The reason being that in that case the avalanche effect can do its works and diffuse the effect of the changes over the state array.

One may apply a permutation or shuffle to elements of the 1600 bits. One may shuffle all 1600 bits with a 1600-state inverter. Preferably at least once during processing. One may also apply it to a lane with a 64-state inverter or to any selection of bits in the 1600 bits. One may also divide a series of bits into k-state elements, like a lane of 64 bits into a sequence of 8 bytes and shuffle the bytes with an 8-state inverter. A more effective way may be to take 9 7-bits words of 64 bits of the 1600 bits and shuffle them with a 9-state inverter and then divide the shuffled 64 bits into a sequence of 8 bytes and inverter the bytes with a 256-state inverter. One will understand that these are merely examples of ways to invert words of bits and shuffle sequences of bits and that many different modifications based on reversible inverters are possible and fully contemplated. One may process these bits by inversion and/or shuffling before or after one of the 5 step mappings as they are called in FIPS 202 are applied.

As an illustrative example, the inventor did run the chi mapping step through all its possible inputs and found that it performs as a 32-state reversible inverter, characterized in Matlab as: inv32-[1 6 11 12 21 18 23 24 10 13 4 3 14 9 16 15 19 22 25 28 7 2 5 8 27 30 17 20 31 26 29 32]. Matlab using origin-1 for indexing, while SHA-3 uses index origin-0. One should adjust for that. The inventor further applied a publicly available Matlab implementation of SHA-3 available from https://www.mathworks.com/matlabcentral/fileexchange/71760-sha-3-hash by David Hill (“Hill”) posted on Dec. 25, 2019, including the functions code at subpages which are all incorporated herein by reference. The chi.m program in Hill follows the FIPS 202 specification. The inventor replaced the chi.m code with the above 32-state inverter, with proper adjustment for index as well as conversions between binary and decimal 32-state representations.

Checking it an a standard ‘hello world” message on a public SHA-3 website it turned out that the use of the inv32 inverter generated the correct 512 bit hash which is: digest1=SHA3 ('hello world’, 512) % or 224, 384, 512 depending on the output length you want ‘840006653e9ac9e95117a15c915caab81662918e925de9e004f774ff82d7079a40d4d27b1b 372657c61d46d470304c88c788b3a4527ad074dldccbee5dbaa99a’.

Next the inventor split the Keccak.m function which executes the Round function 24 times, into ir=0:10 A=RND (A,ir); ir=11:11 A=RND1 (A,ir); and ir=12:23 A=RND (A,ir). Herein in RND1.m the original inv32 is replaced by inv32a=[25 29 7 13 16 32 31 21 17 1 10 2 9 30 28 24 18 20 27 5 4 22 23 11 8 14 26 6 3 12 19 15]. This creates the new hash digest2=‘840006653e9ac9e95117a15c915caab81662918e925de9e004f774ff82d7079a40d4d27b1b 372657c61d46d470304c88c788b3a4527ad074dldccbee5dbaa99a’. The Hamming distance between digest1 and digest2 is 263 which is about 256 (or ½ of 512) which confirms the preservation of the avalanche effect and indicates cryptographic security.

It is just one possible modification. In order to let the avalanche effect of the architecture of SHA-3 do its work one should preferably create the modification a limited time and limited rounds before about 3/4 part of the last round. In SHA-3 that is before round 19 or 18. One may use different 32-state inverters (of which there are factorial of 32 (32!)) for different rounds or the same modified inverters.

One can note in the original inv32 that inv32(1)=1 and inv32(32)=32. This indicates that the words [0 0 0 0 0] and [1 1 1 1 1] are passed through unchanged. One may impose the same condition or a condition that a new 32-state inverter has no states in common with the original inverter in like positions. Or impose a minimum byte or bit distance between inverters. This applies to this specific transformation as well as to other transformations where more than 1 n-state inverter is applied.

Preferably, one sticks as close as possible to the original architecture. This still offers different possible transformations. For instance, FIG. 6 in NIST FIPS illustrates the data flow in the Chi mapping step. In fact, it shows 5 XOR functions, each with 2 operand inputs and 1 output. In accordance with an aspect of the present invention and equivalent to the FLT in FIG. 1 herein one may consider the operation in FIG. 6 in FIPS as an addition over GF(2\hat{ }5=32) with as inputs 2 32-state elements and as output another 32-state element. This is illustrated in FIG. 26.

FIG. 26 shows as 3100 an operation represented by addition over GF(32) with two inputs 3102 and 3104 and output 3104. Inputs 3102 and 3104 are created from inversion by 32-state inverter inv32r of 3101 input ‘in’ which is the 32-state representation of the 5 bit word represented by the top boxes of FIG. 6 in FIPS 202. The derived bits of the 5 input bits are represented by 32-state signal ‘mix’. The operation of 3100 performs the addition over GF(32) of the inverted 32-state input signals and outputted on 3105. That 32-state output signal is inverted by 32-state inverter inv32ri, with inv32r(inv35ri(x))=x for all 32-state x. That result is outputted on 3106. When inv32r is identity one has an unmodified Chi function. One may modify Chi thus in accordance with a 32-state FLT.

Other transformations are possible and contemplated. The above transformations are 32-state transformations. One may easily modify that by processing greater parts of, for instance, a 5 by 5 bit slice of the state array A. For instance, rather than applying the FLT on processing a word of 5 bits in SHA-3 Chi, one may process 2 sets of 5 bits as a 10 bit word with a 1024-state transformation and/or FLT using 1024-state inverters. One change may be to leave on Chi operation on a 5-bit word unchanged or modified with a 32-bit transformation.

There is another mapping step that involves a constant. That is the iota step. One is reminded that a purpose herein is to preserve an architecture of a cryptographic design. One reason is that its avalanche effect usually has well been proven and tested. Changes and transformation are in the implementation of functions or local data transformation. These do not affect general data properties (like statistical uniformity) or meta-properties of functions. The iota step in SHA-3 offers such modifications.

The iota step modifies a center lane of 64-bits in the state array during a round. One may easily change other lanes also in accordance with one or more aspects of the present invention. In iota only 7 bits in the lane are modified. That may be expanded. However, in the spirit of SHA-3 as illustrative example the steps as dictated by FIPS 202 will be followed. Basically FIPS 202 provides an LFSR with 8 bit shift register that is max length and has a 255 bit cycle. That is bit 256 of a generated sequence is identical to the first etc. The generated sequence is sampled 7 times and XORed with pre-determined bits in the lane, depending on the round number. A first possible change is to store the LFSR sequence as a lookup table and shuffle and/or invert the sequence as described earlier. One may for instance use a 256-state inverter to shuffle the bits before they are sampled and XORed. One may also invert sets of bits with an n-state inverter. Or, because a word of 7 bits is created one may invert that with a 128-state inverter, of which there are many.

Another way, is to FLT the XORing of the word of 7 bits into a 128-state FLT. Another approach may be to consider the sampled 7 bits as bits on specific locations of a sequence of 64 bits being 0 in all other positions. One may then divide both the lane and the constant word into for instance bytes of 8 bits (8 bytes each) and perform an FLTed addition over GF(256) using a modifying 256-state inverter. All these modifications create a numerical change in the output hash. And may be used once for every message that is being processed.

Restart encrypted communication between two computing devices. When a connection between two machines, for instance working under TLS 1.3, is interrupted or suspended, one may use encryption based on a new self propagated inverter to continue data exchange without restarting the base handshake, which is time consuming. There are currently ways to do a rapid restart, including in TLS 1.3 the 0-RTT (Zero Round Trip Time) resumption. However, there are some replay and other risks with current resumption approaches. By using a next self-propagated n-state inverter in for instance an FLT-modified encryption, one has enabled a very fast and highly secure resumption without the need to establish a new session key and the handshake involved in that. One may synchronize using for instance packet IDs. So even when connection is lost before a resumption element is transmitted like a PSK (pre-shared key) or session ticket, the connection may securely be continued. This is for instance useful when connection is suddenly lost by noise, fading or source obstruction in wireless. One can set conditions under which self-propagated inverter reconnect may be applied. Time of interference, frequency of interference and interruption and failure of decryption may stop re-connect and restart a full handshake. But in many circumstances the above allows for a rapid and secure reconnect and continuation of encrypted communication. It prevents overloading of server activity that otherwise may be busy with handshake protocols. It also ensures continued connection in time-critical machine to machine communication. And because there is no exchange of inverters at all, only ciphertext is based on the inverter which as stated earlier does not leak inverter information.

There are several transport layer protocols that keep track of correctly transmitted and received data sets such as packets or blocks. These include as illustrative example QUIC, SCTP and TCP. One property is that these and other existing transmission protocols allow determination, usually by some identification, which data set such as a packet has been delivered correctly to a receiver. In general, security of restart of communication may involve negotiating a new key as one is unsure if such interruptions were created intentionally by an attacker. This renegotiation is often a most expensive part of resuming communication in processor time and delays. The use of self-propagating inverters may address this need. By having an ID of a last packet or message or block one may determine what the last applied n-state inverter was. Resuming decryption by generating the next self-propagated inverter makes it infeasible for an attacker to successfully decrypt the next packets. A computational function transformation based on such secret inverter takes place in an extremely large solution space. The use of self-propagating inverters in a large set of self-propagating inverters (in the order of 100 of millions, preferably greater than 1 billion), makes communication restart after communication interruption fast AND secure.

It is also a defense against jamming and re-connect/replay attacks. In a similar way one may apply the self-propagating inverters to modify encryption per block of encryption in AES-CTR/GCM and/or ChaCha20. One may also change encryption per packet of for instance a Virtual Private Network (VPN) connection.

In many applications one applies light weight encryption. Light weight here is usually 128 bit keys and at least 122 bits of security. An example is ASCON which has been published by NIST as SP.800-232. These lightweight cryptographic methods provide secure encryption that can run relatively fast on processing constrained devices. Other lightweight encryption is well known and may include: AES-128, Speck, Simon, Hummingbird, Twine and Katan for instance. Details of these methods are easily found on line. A collection of lightweight cryptography methods is provided on NIST webpage https://csrc.nist.rip/Projects/lightweight-cryptography/round-1-candidates which is incorporated with all its descriptive files herein by reference.

One example of a lightweight cryptographic application is Ascon. Ascon provides authenticated encryption, fixed-output-length hashing, and an extendable Output Function (XOF) to generate sequences of variable length. The original submission also included a post-quantum variant (Ascon-80pq), which is not part of the final NIST standard. Additionally, a 64-bit key version was proposed by the original developers but excluded from the NIST specification. The Ascon permutation function consists of three layers: a bitwise substitution layer (using a 5-bit S-box), a linear diffusion layer (using rotations and XORs), and a constant-addition layer. Operations are performed on a 320-bit internal state, represented as five 64-bit words.

It was already explained that FLT and CFT may increase security dramatically of for instance encryption like AES and ChaCha20 and variations thereof. Possible to a solution space 10\hat{ }500 or greater. Lightweight cryptography is presented as a solution for resource constrained devices that require at least some form of cryptographic security. Another view is that size and price both of memory and processors has developed such that including transforms as disclosed herein increases security while only increasing size and price marginally or not at all. In fact, the transformations allow a lightweight cryptographic method of a puny 84 bit security or a decent but minimal security of 128 bit to a dramatically increased level. A differentiator of a lightweight method is often the speed it works with. Generally faster than the heavyweight methods like AES and ChaCha20.

The lightweight methods have sufficient “transformation points” that allow to implement security enhancing methods and ways disclosed herein. A transformation point in a cryptographic method is a datapoint or a function that may be transformed in a manner as described herein. In Ascon, as an illustrative example, there are several ways. 1) transform the key and nonce. Assuming size of 128 bit which is 16 bytes one can concatenate and then shuffle all bits with a 256-state inverter or invert the bytes or other word size. 2) one may either invert or shuffle the 320 bit state with appropriate inverters. 3) one may invert or shuffle the S-box of 32 5-bits elements with an appropriate 32-state inverter; and 4) one may FLT or transform the bitwise XORing of words of 64 bits, for instance by considering them as words of 8 bytes and the combining as addition over GF(256) of 256-state elements and transform the addition in accordance with an inverter. This is one set of modifications and other transformations are possible and fully contemplated and may include resizing of words of bits.

One may desire to maintain speed of Ascon over processing a message and applying all possible modifications for all steps and all rounds may not be beneficial to maintain overall processing speed. One may program to modify only one or limited number of steps per round. By using one or more self-propagating inverters one may vary the modifications per modification. Furthermore, one may create a Just in Time (JIT) structure where a modification is assigned its own processor or processing core that generates a particular modification or modified table while a main processor is performing the steps of the base Ascon architecture. Such an approach ensures that a modification is only computed when it is needed and does not require pre-computation or pre-storage. It creates an Ascon architecture that is unchanged but with a dynamic Just-in-Time implementation that performs a modified Ascon in the same time or close to the same time as the unmodified Ascon but with a much higher security then its initial key size seems to imply and with exceptional speed.

One may use Ascon XOF itself to expand an initial key to required length for an n-state reversible derived reversible inverter. Ascon generates state updates in a one way manner with repeatability at transmission and receiving side.

Ascon is used herein as an illustrative example. In accordance with one or more aspects of the present invention one may apply one or more of the transformations herein to revive cryptographic methods that are currently considered broken.

As an illustrative example, the inventor has taken the known and insecure RC4 encryption, also known as Rivest Cipher 4, as an example of applying an FLT or CFT security improvement. RC4 is blazingly fast and (if not for being insecure) a great application of a lightweight encryption method. The inventor found a simple Matlab implementation of RC4 at Matlab Central by Gokula Krishnan. The RC4 Matlab code therein has no other meaning in that it is publicly available and it works and is tested. Other published public implementations of RC4, for instance in C and Java are available. Furthermore, one of some searching skills will be able to find one or more reference implementations on-line.

The Krishnan implementation may easily be modified with the FLT. One line of Matlab code in the Krishnan implementation is ct1-bitxor(pt(ii),keystream(ii));. Herein ct stands for ciphertext and pt is plaintext and keystream is of course the keystream.

It has been replaced by the inventor by: ct1=sn256(pt(ii)+1,keystream (ii)+1)−1;.Herein sn256 is an FLT version of sc256 which is the standard addition over GF(256). The output has first been tested with sc256 replacing the ‘bitxor’ statement. And the same result was generated. One does sn256=labtransform(sc256,inv256); to create an FLTed version of sc256. The generated result or ciphertext is then different, but using the same FLT will be decrypted correctly.

One may generate from a common key, for instance generated by PKI and preferably by PQ method such as Kyber and as explained above create an extended sequence of elements. One may for instance create a unique 512-state or 1000-state reversible inverter. One may use the larger k-state inverter as a self-propagating inverter. This is a relatively fast process by invn=invn (invseed) in Matlab. One may also use a lexicographical permutation to generate a new reversible inverter. One then derives simply a 256-state inverter by dropping all elements >256 (in Matlab origin-1 or >255 in origin-0) from the sequence and a 256-state reversible inverter is left. One may even dynamically change the number k, by upping every predetermined time the number k. For instance, when 25 512-state inverters have been generated, one may up k to 520, extend the current 512-state inverter to 520 elements. This can be achieved for instance by adding 8 elements occurring at multiples of position 25, like p=25, 50, 75, 100, 125, 150, 175 and 200, and then replacing the original 512-state elements in their positions with the position of the corresponding elements at the end of the sequence. One may run the self-propagating 520-state inverter at least once and the process of deriving 256-state inverters starts again. Many parameter changes herein are possible, creating a virtually infinite series of changes that make successful attacks infeasible.

Significant brute force attacks are required to successfully break this RC4flt encryption. This forms a valuable in-depth protection that creates a barrier against attackers. There is yet another important benefit. Some devices are attacked for nefarious purposes to intercept real-time control of a device for instance. The FLT allows the use of fast lightweight encryption that is infeasible to attack real-time and protects real-time applications. In order to break an FLTed encryption likely days if not weeks and probably longer is required. Breaking FLTed encryption after an undue period makes the breaking moot. It defeats efforts to take control by an attacker of a real-time device.

Keys of length 128-bit are popular in lightweight encryption. Encryption using keys of 64 bits or larger are still in use. For that reason, in an embodiment of the present invention keys of 64 bits or larger are used in combination with an FLT, preferably modified by an n-state inverter generated by a self-propagating seed inverter.

Encryption like AES-GCM, ChaCha20 and Ascon are validated encrypting methods, better known as Authenticated Encryption with Associated Data (AEAD). An added tag is provided that validates the encrypted data or ciphertext. This means that one may transform the encryption by FLT for instance and still validate the ciphertext. In accordance with an aspect of the present invention the AEAD function is transformed with an FLT and/or an n-state inverter and/or an radix-n transformation as described herein. In Ascon, AEAD is interwoven with encryption by its internal state. Thus, AEAD computation in Ascon will automatically change when functions are changed in encryption. In ChaCha20 and AES-GCM the situation is a bit different where tag and ciphertext are computed separately. The common element there is the key. But if the key is known one may compute the tag from the (modified) ciphertext, which is public and the key (and nonce) and added data. Full protection of the tag may be achieved by modifying with a transformation as described herein of a function in the tag computation. That is where a self-propagated inverter would contribute immediately to making a tag unpredictable.

The inventor may be his own lexicographer. One term used herein is the term Finite Lab Transform or FLT. This means a 2-operand n-state operation is modified as explained in FIG. 1. The FLT may be implemented as such with the n-state inverters. One may also for convenience create a lookup table that represents the outcome of an FLT by using all possible input operands. This makes an implemented FLT extremely fast. One may then call the result of applying the FLT an FLTed function or FLTing a function.

A function herein is a computational function realized by physical elements. While being represented as a table or even mathematical expressions, all functions herein still are computer functions. A computer function is a discrete switching function that is characterized by an n-state table with n=2 when the operation is called binary or n>2 for other operations. These functions are in accordance with the Blaauw framework, described as an expression but executed by a physical device. Thus, any computer function herein maps directly to a physical device.

One aspect of the current invention is the transformation of a carry-less function (represented as an addition over GF(2\hat{ }k), for instance) into a carry propagating function. A carry propagating addition herein may be called a radix-n function. It is based on a carry ripple adder structure wherein an addition is performed by a combination of a residue and a carry function on n-state elements. But the radix-n operation herein may be different that it applies a random looking carry function and the carry and residue generating functions may be modified based on n-state inverters.

A future threat to symmetric encryption such as AES and ChaCha20 may not directly come from quantum computers but rather from clever hacker attacks. Applying the herein provided methods provide a huge barrier against breaking encrypted data. Even stealing keys will not enable an attacker to successfully break the transformed methods. In one embodiment computing devices that perform the transformations are kept behind a firewall, so that the transformation itself it never exposed in cloud servers and preferably not to internal clients in a network behind the firewall. Management of the transformations is largely a management of the required n-state inverters, which may be done by classical key management systems.

High security may be obtained by custom installation of n-state inverters or their seeds on participating computing devices. Which may be a challenge in much of current Internet data exchange wherein connections are established on an ad hoc basis using PKI. To that end, the inventor invented a novel way of what may be called PKI based generation of n-state reversible inverters. The required n-state inverters may require 256-state reversible inverters or even much larger values of n. In accordance with several aspects of the present invention, one or more methods and devices are taught herein that transform a sequence of n n-state elements which is NOT a reversible n-state inverter, into a reversible n-state inverter. Examples are provided. Furthermore, one may not want to store or prepare dozens, thousands or millions of different n-state inverters. The use of self-propagating n-state inverters with may generate billions of different n-state inverters are disclosed.

Furthermore, it is generally undesirable to change an infrastructure to transmit key-like 256-state inverters or sequences in the current PKI, where 16 or 32-byte keys are the norm. The inventor disclosed the use of KDFs and/or Key Expansion functions that expand (in a seemingly random way) a relatively small key of for instance 16 or 32-bytes or 64 bytes into a larger sequence for instance being 256 or more bytes. The thus generated n-state sequences that most likely are not n-state inverters are then transformed into n-state reversible inverters. This was demonstrated for n=65536, showing that this by itself is not a computational problem.

This means that one may apply current PKI to achieve the required variations and astronomical number of possible variations and/or transformations. Concerns about quantum computer attacks may be addressed by using PQ PKI as disclosed in FIPS 203 and/or FIPS 204 if one prefers a signature-like approach.

The Finite Lab-Transform or FLT is a patented invention by the inventor of the aspects of the present invention. It is extensively described in U.S. patent application Ser. No. 18/097,396 filed on Jan. 16, 2023, which is incorporated herein by reference. It was also disclosed in U.S. patent application Ser. No. 15/442,556 files on Feb. 24, 2017 and issued on Dec. 24, 2019 as U.S. Pat. No. 10,515,567 which are both incorporated herein by reference.

Aspects of the present invention relate to data elements that may be represented as n-state elements or words of bit for instance that represent a value n. Aspects of the present invention may apply to a range of small to large data elements, like elements represented by 256 bits or more. To present the explanations provided herein in an understandable manner, often illustrate examples for small n like 3 bits (or k=3 bit words n=2\hat{ }3=8) are used. This may appear as not creating many variations. One is cautioned that the so called “combinatorial explosion” may kick in for larger values of n. For n=4 there are 24 different 4-state reversible inverters, for n=8 there are 40,320 different 8-state eversible inverters, and for 8 bits or n=256 there are over 10\hat{ }500 different 256-state inverters. Preferably, encryption that is transformed uses a key of 64 bits or greater. Operations that are modified preferably are at least 4-state operations, more preferably at least 16-state operations and most preferably at least 32-state operations.

All numerical examples have been executed in working computer programs, most in Matlab. Providing a numeric 65536-state reversible inverter is confusing by its size and only its beginning and ending have been included. However, a Dell Computer on which an old version of Matlab was installed had no problems in rapid execution, in that case using a stored look-up table. One of ordinary skill is able to repeat the computations based on the details provided herein.

For convenience the computer language Matlab has been applied in demonstrating aspects of the present invention. This Matlab language is close to pseudo-code and easy to understand for one of ordinary skill. However, all aspects are implementable in other computer languages, including Machine Language, Assembly Language, Interpreted Languages and Compiled Languages. This may include C, C++, Java, Python, Rust, Mathematica, Go, C#, Ruby, Magma as illustrative but non-limiting examples.

Matlab is known for its speed in array or matrix processing. However, Matlab's array indexing works from starting index 1 (origin-1) instead of index 0 (origin-0). This is by itself not an issue and actually illustrates that the computations performed in Matlab using lookup tables or otherwise implemented switching tables have no inherent mathematical meaning, but are only meaningful in providing a state transformation, which is a machine property.

The above modifications and/or transformations, which may be named Computational Function Transformation (CFT), preserve the basic architecture of a cryptographic method, while its effective function implementation is transformed. It is based on the computer design framework as articulated by Prof. Dr. Gerrit “Gerry” Blaauw (architecture/implementation/realization). As a consequence, a statistical analysis of the modified cryptographic data in for instance ciphertext does not reveal or leak information about a change. There is a growing need for more secure cryptography especially in encryption, but also hashing and digital signatures. Other efforts to improve for instance encryption security involve larger keys, larger state arrays and/or more execution of rounds. This may change the basic and proven architecture and in general requires significant re-design of existing methods and may place greater demands on computation power, code re-design and/or execution time, which may not achieve optimal performance and with limited control by data owners. These issues are either circumvented or addressed by the devices and methods disclosed herein as one or more aspects of the present invention.

Herein operational functions and/or data in a cryptographic method and/or device are transformed in accordance with preferably a reversible n-state inverter. The reversibility of the n-state inverter ensures that the transformation does not introduce a detectable change in the cryptographic output. This has been checked with for instance measuring Hamming distance between cryptographic outputs such as hash and/or ciphertext based on identical plaintext or input data with different transformations. No significant indications in for instance Hamming distance between the modified results reveal a change.

This points to certain aspects of the herein disclosed transformations. For instance, the complete FLT of an addition over GF(n=2\hat{ }k) provides a function that is also an addition over GF(n=2\hat{ }k). However, the number of variations is not linearly related to n. For n=8 there are 40,320 different 8-state reversible inverters. However, due to the structure of the involution of the addition over GF(8) there are only 240 different additions over GF(8). The inventor has made several reasoned and empirical estimates of bounds of different variations of GF(n=2\hat{ }k) based on n=2,4 and 8 complete and large tests for n=16. A low bound is number_variations=n!/(k!*(n−1)) with k=1/2 n. For n=256this provides about 10\hat{ }288 variations. A more reasonable (and higher) bound based on the addition being in base form a bitwise XOR, leads to n!/|GL(p,2)| with |GL(p,2)|=(2\hat{ }p−2\hat{ }0)*(2\hat{ }p−2\hat{ }1)* . . . (2\hat{ }p−2\hat{ }(p−1)). This leads to about 10\hat{ }478 variations for n=256 or p=8. Another even higher estimate is (n−3)!. For n=256 the number of variations is of course enormous and it practically doesn't matter what the correct bound estimate is. Practically, the variations are so large that any brute force attack is infeasible. Using the FLT for n=256 makes cryptographic brute force attacks infeasible. While somewhat smaller, even n=128 guarantees more than 10\hat{ }100 variations.

The FLT preserves that the transformed addition over GF(n) is also an addition over GF(n). So when applied in for instance AES-GCM and keeping the FLT secret, it increases security while preserving a proven mathematical structure. The important aspect, based on analysis, is if modification in switching functions and/or data transforming devices substantially modify the statistical make-up of the output of these devices. These transformations leave the output generally with a random character that make them statistically indistinguishable from unmodified functional methods and/or devices. The most important property in one aspect is that a changed function or data doesn't change the statistical make-up of the output.

One may apply a replacement of a function either by changing the base function or transforming the base function that leaves the statistical properties of being random without a bias unchanged. A first requirement is that a function has to have a flat or uniform sum-space as defined earlier. This has as consequence that function doesn't have to be an addition over GF(n=2\hat{ }k) in the binary case, as in replacement of bitwise XORing of k bit words. It means though that an addition over GF(n=2\hat{ }k), as an illustrative example, must be replaced by a reversible n-state function to keep random performance intact or largely intact so that the replacement or transformation cannot be detected in the output data.

The inventor checked the number of variations in several replacements and transformations for n−8. Similar differences apply to both n=2\hat{ }k and n being prime. It is provided herein as an indication of possible variations. For instance, instead of modifying a base function like an addition over GF(8) represented by bitwise XOR with a complete FLT, it is transformed by a partial FLT wherein only the input operands are transformed with an 8-state reversible inverter and the output is not transformed or transformed with identity, which has a same effect. In that case 5040 different functions are generated or n!/n which is (n-1)!. The output is in that case a reversible commutative function, which generally is not an involution and is not generally associative. However, the sum-space is uniform and optimal.

One may also start with a modified addition over GF(8) which does not have z=1 as zero element (in Matlab origin-1) of this addition over GF(8). In that case there are a full 40,320 different partial FLTed functions, including the original function. That is n!. In case of AES-GCM/CTR the lack of associativity requires that one applies the same order of operation in for instance AddRoundKey( ) if one replaces the original addition over GF(n) with a partially FLTed function. But repeatability is important in any one-way creation of an output, not reversibility. And the same applies to ChaCha20 and hashing steps. Despite that the partially FLTed functions are all reversible if one so desires and the principle is quite simple. One may consider any commutative reversible function as (c=a+b). It follows then that a=c−b. If one considers b as a constant for convenience, then c=a+b for an n-state operation may be considered an n-state reversible inverter as a bth column in an array of n reversible n-state inverters. The reversing operation a=c−b is then the bth column in an array of reversible inverters which are all the corresponding reversing inverters corresponding to the original (c=a+b) array. The symbol ‘+’ herein only indicates a commutative reversible n-state operation, and nothing else. The element a in c−a+b and c in a=c−b indicate a row index in the array and in the inverters, respectively.

One may also apply a partial FLT with no inverters (or identity) at the input and one of 40,320 inverters at the output of an FLT. This generates 40,320 different 8-state functions.

For convenience certain computer functions that are described as commutative 2-operand involutions herein are described as addition over finite field GF(n) (GF=galois field). The base requirements for a finite field are well known. Commonly one uses for base operations the terms addition and multiplication over a finite field. In fact, a better term in the literature are requirements for two Laws of Composition for a finite field. A first law of composition may be called an addition over a finite field and requires for instance being commutative, associative and having a neutral element z so that the operation which may be called sc has as requirement sc(a,z)=a for all a in the finite field and each element in the finite field ‘a’ has an inverse ‘ai’ relative to z. For convenience the term “addition over a finite field” is used and maintained herein, also for novel FLTed functions. It means a law of composition for a finite field that complies with all axioms required and applying to the finite field addition formed by word-based XORing of words of bits. So an FLTed function for n=2\hat{ }k that meets the requirements may still be called an addition over GF(n=2\hat{ }k). A 2-operand commutative n-state involution that does not meet each of these requirements, such as not being associative or failing to have a neutral element or zero-element that applies to all elements in the set, is not an addition over GF(n), or does not meet all the requirements of an addition over finite field GF(n). The mathematical terms are used to describe the behavior of circuitry. This circuitry, which of course, as explained earlier do not actually perform mathematical operations.

The above describes transformations. One may also replace the base function and then transform, with FLT or a partial FLT. One may do that as long as the base function is reversible, preferably commutative and with a sum-space that is optimal and uniform (n different classes of n outcomes. For instance, for n-8 8 classes of 8 groups of outcomes. (64 outcomes with 8 1s, 8 2s, . . . , 8 8s, for Matlab origin-1).

One may select a base function that cannot be created by an FLT of another function. For instance, one may use for n-8 the novel involution si8=[1 2 4 3 5 6 8 7;2 1 346578;43 2 1 8 7 6 5;3 4 1 2 7 8 5 6;5 6 8 7 1 2 4 3;6 5 7 8 2 1 3 4;8 7 6 5 4 3 2 1;7 8 5 6 3 4 1 2] which is not an addition over GF(8). This specific involution constructed by the inventor, generates 5040 different variations from 40,320 different 8-state reversible inverters, or (n−1)!. Using a partial FLT only inverting the inputs one gets 10,080 different variations, or 2*(n−1)!. Using the partial FLT with only transforming the output, generates 40,320 or n! different variations. Yet, another replacement is using an addition mod-n table or a variation (like FLT) thereof as a base function. Similarly, one may use a function subtraction modulo-n as a replacement for the base function addition over GF(n). All these replacements generate at least (n−1)! variations. Furthermore, one may use a transformation like an FLT or partial FLT as the base function, making successful attacks yet more difficult.

The inventor has previously disclosed novel and non-obvious n-state involutions for n=2\hat{ }k that are not additions over GF(n=2\hat{ }k). This is taught for instance in U.S. patent application Ser. No. 18/750,970 to Lablans, filed on Jun. 6, 2024 and incorporated herein by reference. These methods are after disclosure in one or more patent applications also described in the open literature and easily available to one of ordinary skill.

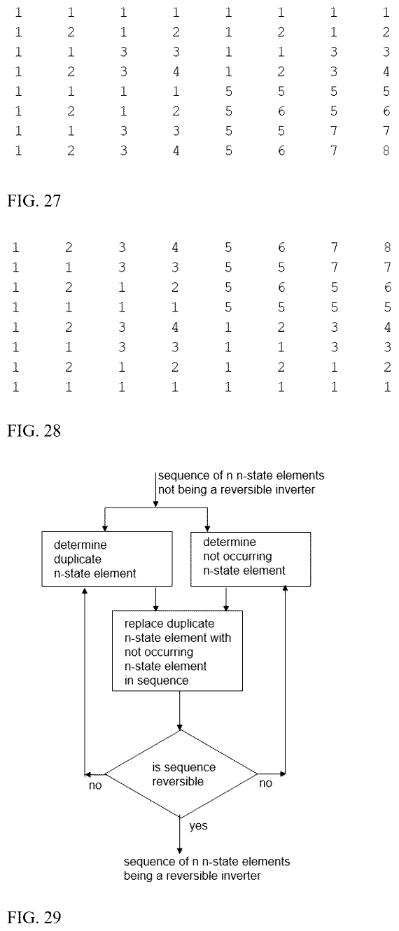

Another transformation or replacement, is the earlier mentioned radix n-transformation. In one embodiment one replaces a carry-less n-state operation like an addition over GF(256) with a carry propagating operation. For instance, instead of doing in AddRoundKey( ) a column wise addition of 4 256-state elements over GF(256) one may consider a column in the AES state array as a 256-state word of 4 256-state elements. The combining of 2 columns is then the addition of 2 256-state words of 4 elements with carry propagation. The radix-n transformation to a reversible carry propagating addition-like operation, is illustrated by 8-state carry table in FIG. 27 and the corresponding 8-state borrow table in FIG. 28. The 8-state residue generating function is the base addition over GF(8). One applies the carry/residue operations in the classical carry ripple addition. Similarly, one applies this structure to recover an input by performing a subtraction. The subtraction and addition over GF(2\hat{ }k) are identical and the borrow function is created by flipping row wise the carry array. One may determine the n=2\hat{ }k state carry array from the base 2-state carry which is the AND function. For the 8-state carry array one does the bitwise AND of words of 3 bits and translate them into a decimal representation.

As explained earlier, one may FLT the base carry ripple addition (for instance with residue function modulo-n addition or addition over GF(n)) as well as the corresponding carry and borrow function. One creates an FLTed reversible carry propagating operation. As demonstrated before, for the residue function being modulo-n addition one may use any n-state carry function and still be reversible as long as the matching subtraction and borrow function (flipped) are used. One may then FLT these functions. For one-way applications, such as keystream generation, one may use any n-state carry function with a reversible n-state residue function and still preserve an optimal uniform sum-space. One may apply this in for instance AddRoundKey and/or Key Expansion in AES. For combining keystream and plaintext a reversible approach is required if one wants to be able to decrypt.

It was shown that one may create any n-state reversible inverter from a preferably random or pseudo-random sequence of k n-state elements or that can be represented by k n-state elements with k<n, from k=n and from k>n. One may also create a k-state reversible inverter and when k>n and then reduce it to an n-state reversible inverter. One may apply the n-state reversible inverter to invert the n-state elements in the input data, key, key schedule, or state array and others at least once. One may also shuffle data arranged in a certain order, such as again a key schedule or a state array. For instance, the AES state array is an array of 128 bits or 16 bytes. One may shuffle the sequence bitwise with a 128 state reversible inverter or shuffle the 16 bytes with a 16-state reversible inverter. One may apply all of the above. One may also invert and/or shuffle plaintext data and/or ciphertext data, which may de recovered with a reversing inverter. Coding of these operations and preferably a secret coding may be included to indicate which operations are replaced and/or which data is replaced. Replacement herein means substituting data and/or an operation for another.

In certain cases, cryptographic methods have been modified. For instance, in AES it has been popular to modify its S-Box content. However, the S-box has a property of being a special 256-state reversible inverter. One weakness of a modified S-box is when it is self-reversing or when certain elements in the S-box transform onto itself. One has to be careful in modifying it by an untested inverter. In one embodiment one may apply an n-state modified or replaced S-box. if and when that is applied in for instance a limited number of rounds, like one round. This and other one-time or limited time replacements and/or modifications will be absorbed through the known avalanche effect in AES of multiple rounds. It modifies in that case the ciphertext but does not reveal detectable statistical modifications.

A functional modification, replacement or transformation is mostly different in that in most cases significant operational properties are preserved and thus fundamentally does not modify the probability of the performance. Many cryptographic operations, including hashing such as SHA-256/512 applies multiple constants, that may be called K-constants. In one embodiment one may modify and/or replace one or more constants in one or more rounds. A K-constant is 32 bit long and one may for instance shuffle a K-constant with a 32-state inverter or consider a 32-bit word a set of 4 256-state elements (or bytes) and invert these with a 256-state inverter, for one or more rounds. Preferably for at least one round. or for just one round.

The base function represented by bitwise XORing may be replaced and/or transformed by any of the above methods. In general, the function represented by addition over GF(n) is applied in key stream generation, and also in combining keystream with plaintext and may be applied in one, or both of these applications. Encryption and hashing methods have multiple rounds as well as other transformation and/or replacement points. For instance, ChaCha20 and AES-GCM/CTR apply bitwise XOR both in combining keystream and plaintext as well as in keystream generation. One may apply the replacement/transformation at different points in a method and also apply different base functions and different transformations. These modifications are cumulative in increasing security.

In an environment requiring extreme security, one may want to change the applied n-state inverter for CFT for each block in a block cipher such as AES-CTR/GCM or ChaCha20. Or one may want to update the applied inverter at least every 10, 20, 100, or 1000 blocks. Or any other maximum blocksize.

PKI (public key infrastructure) is associated with sharing a common key for symmetric encryption. It may be used for other purposes also, where a secure common key or elements or sequence is required. As an illustrative example, one may want to apply a CFT change. For instance, one may want to apply a different CFT in encryption on a daily basis. One will understand that a daily change is only an illustrative example and a change may happen at intervals that may be regular or not, or after a number of encryptions, for instance after one or after 5 encryptions. One may, assuming for illustrative purposes a daily CFT, which may offer a sufficient increase of confidential encryption. This may be established by a PKI exchange to establish a common key or sequence between two computing machines.

PKI in general is defined as creating a common key of a certain length. Like a Kyber key of 32 bytes. RSA and classical Diffie Hellman create larger key sequences that have to be decreased by a Key Derivation Function. For current purposes, one wants to increase a size of for instance a PKI key like Kyber 32-byte to a 240 byte, a 128 byte, a 256 byte, a 512 byte, or a 65536 byte or to any other useful size that may be transformed to a reversible inverter. The key encapsulation mechanism of Kyber is such that the initiative to start generating a common key comes from a client, not from the server. This may influence where certain actions are taken.

In accordance with an aspect of the present invention, one may use other PKI based key exchanges. One may use even ones that may be deemed borderline insecure, like some sizes RSA or Diffie Hellman PKI operations. In that case one may require a secret number of self-propagating steps of reversible n-state inverters derived from those keys. For instance, one may require a new starting or seed inverter state after 21 million self propagating iterations. The unpredictability of invseed as well as selected transformation points create high security applications that are difficult to break by brute force as all these steps act cumulatively for security.

As an illustrative example use a 128-state reversible inverter as a seed “invseed”. Run the self propagating inverter invn=invn (invseed) for 100,000 cycles to rid any internal cycles and make invseed=invn at that point. Then run the self-propagating inverter using the new invseed moved one position as in invseed=circshift (invseed,−1) for instance. And test for each seed inverter the maximum cycle length. In one example for n=128 a Matlab progam ran for 127 shifts and gave a series of outcomes with the maximum cycle being cyc=973,245 for k=97 shifts. And a slightly lower next length cyc-946,473 for k=87 shifts.

In accordance with a further aspect of the present invention, an n from k inverter extraction is provided. It was already observed that the max cycle length of self-propagating inverters increases significantly with greater n-state inverters. An observed effect is that for instance for n=256 a maximum length may be well over a billion different inverters while for n-128 that number may be about a million. An extraction works as follow: one initiates a max cycle k-state self-propagating inverter, for instance k=1000. One then extracts from each 1000-state inverter, for instance, a 256-state inverter. One way to do that is removing all elements with value greater than 256 without changing the order of elements that remain. That will leave a reversible 256-state inverter (in rigin-1 in Matlab. A slightly different approach is a variant of the earlier disclosed converting a sequence of n elements with duplicates into an n-state reversible inverter. From the sequence of k k-state elements one identifies a sequence of n k-state elements. Use the first n k-state elements. One determines which n-state (or 256-state) elements are in the sequence and leaves then in their position. One also determines which n-state elements are missing and which of the k-state elements in the sequence of n k-state elements are NOT n-state elements. One then substitutes each non-compliant occurring k-state element with a non-occurring n-state element. One may do this based on different criteria, but an easy way is to do that on ab increasing value way.

The CFTs, shuffling and inversion creates an enormously large modification space. Even using a single or multiple modification points based on a single base or seed inverter, will increase security with combinatorial/factorial level of security improvement, possibly in the order of 10\hat{ }500 and larger. One may call this a static modification. One may make it more dynamic, for instance by cycling for modifications through the different rounds where the modification takes place in one or 2 or more rounds. Another way is to invert the state array in AES and ChaCha20 in part or entirety with an updated self-propagating inverter. Or apply any other CFT, FLT or transformation as provided herein with a changing self-propagating inverter.

One may also invert the counter bits (usually 32 bits) in AES-CTR/GCM or ChaCha20. One way to invert the counter of 32-bits is to apply a 256-state inverter to each of 8 bit words in the 32-bit word. One may vary the inverter size and the word sizes. One may also invert at least 2 words of the 32 bit word with different n-state inverters. Similarly, one may invert or shuffle the (often 240 byte) key schedule of AES. Or apply other when size is different.

AES generates a keystream in blocks of 128 bits or 16 bytes. In practice large multi GB files that need to be encrypted are generally broken up in smaller sizes or chunks, called chunking and encrypted separately. For n=256 self propagating 256-state inverters almost without exception have (using for instance a Matlab circshift version from a seed inverter) at least 1 version that generates over 500 million different inverters. This provides more than enough variation to encipher even files up to 8GB in a single encryption session with each block using a different variation of an 256-state inverter. Even if one re-uses such inverters when it end-cycle is reached, the predictability is so minimal as having no practical influence on security.

It should be clear that FLT, CFT, n-state inversion and shuffling create unexpected and astronomically sized variations, especially for larger numbers for n in n-state such as n being greater than 95 for instance or n=256 or even greater n=65536. These variations, in accordance with an aspect of the present invention, may be different from each other, in the sense of having a same input such as plaintext and same secret key and other parameters, a variation created by a different inverter which may be an instance of a self-propagating inverter, generates a different output such as a ciphertext or a hash. These variations may be applied dynamically, per processed n-state element up to a word of two or more n-state symbols.

There are different ways to achieve dynamic changes of inverters. A multi-core processor may assign one or more cores to compute the updates self-propagating inverter. Such a just-in-time approach ensures that an updated inverter is available at processing a next block. One may apply inverter updates to larger sets of data, for instance to packets in Internet transmission. For instance, in a VPN transmission one may use 1 or more new inverters to encrypt all bytes in a packet with a modified encryption. This allows a buffer time with just a single update to set up encryption/decryption.

The transformations and variations may be applied to existing cryptographic machine operations, such as defined by standards such as NIST FIPS, Internet RFC, OIS and other cryptographic standards. They may also apply to modifications that change a base architecture of a cryptographic process. For instance, one may generate a key-stream by way of an FLTed n-state feedback shift register (FSR). This may be implemented as an array-vector multiplication, benefiting from existing array processing standard processing libraries. One may also apply a keystream generator created by a dynamically changing hash like SHA 256/512 or SHA-3 or other.

In accordance with an aspect of the present invention one may generate an unpredictable keystream by using a hashing application such as SHA-256/512 or SHA-3 or any other hashing application that is modified based on an n-state inverter, which preferably is reversible. For illustrative purposes SHA-256 will be used to illustrate the approach. SHA-256 processes blocks of 512 bits to generate a hash of 256-bits. One may use a variable input of 512 bit to generate each time a block of 256-bits hash. One may also use SHA-512 which generates 512 bit hash. However, this requires 80 rounds per block. One may thus create a keystream of blocks of 256 bits with SHA-256.

### An Illustrative Example

There are several steps one may apply to change and apply standard hashing and/or encryption methods generate a block or series of different blocks of keystreams that may then be combined with plaintext to create a ciphertext.

The following example applies a dynamic modification of SHA-256 based on a self-propagating 256-state inverters from a concatenation of same block of plaintext and part of a different instance of a self-propagating inverter.

The plaintext block of 256 bits or 32 bytes is block='12345678123456781234567812345678′. The applied hashing is standard SHA-256, which is FLTed in round i=32. In that round only one step, in Matlab coded as T_3=binary Add (T_2, K(i)), is FLTed to T_3=addnewflt (T_2,K(i),sc,car,n,p,invn). The standard operation binary Add is a binary addition modulo-2\hat{ }32. The modified and novel operation addnewflt is a modified radix-256 operation of 4 256-state elements, with residue operation ‘sc’ which standard is an addition modulo-256, ‘car’ is the carry function which standard provides car (a,b)−0 when the sum of a and b is smaller than 256 and i 1 when the sum of a and b is 256 or greater. One may have to adjust tables for origin-1 in Matlab. In ddnewflt(T_2,K (i),sc,car,n,p,invn), n is 256 and p=4 and invn is a 256-state reversible inverter. Without an FLT the decimal value of an addition of 2 256-state or radix-256 numbers is the same as the decimal value of adding the 32 bit representation of these numbers.

In this example both ‘sc’ and ‘car’ functions are FLTed with inv256 as reversible inverter. The standard process has more additions and rounds that can be FLTed. However, for simplicity only this expression in round i=32 has been FLTed.

In order to facilitate verification of the examples, a publicly available Matlab program implementing standard SHA-256 has been applied. The program used is: “JOEL LEMAYIAN 2025). sha256 (https://www.mathworks.com/matlabcentral/fileexchange/106865-sha256), MATLAB Central File Exchange. Retrieved Apr. 14, 2025.” This program is freely available online. The inventor appreciates the availability of this program, however, other similar programs both in Matlab, Python, C and other languages are available online. Thus no special significance should be given to FLTing this specific program, as FLTing other available programs will provide identical or equivalent results.

To show initial performance as key generator inverter inv256=1:256 (identity) will be used. A program will convert the vector of 256-state elements into a string by the instructions:
strinv=num2str(inv256);
strinv=strrep (strinv,‘’, “);
var=strinv(1:32);
intext=[block, var]

Because strinv has spaces as well as elements such as ‘244’ which is 3 bytes long, var=strinv(1:32); is used to create 32 bytes with intext being 512 bits or 64 bytes long: intext='1234567812345678123456781234567812345678910111213141516171819202′.This generates standard SHA-256 hash: 5E920A4AA84260714C2A070E3D7156E1F0D1293ECD9D3AA3C8B3C99706DCB87C, which one may check online in any standard online SHA-256 hash generator.

The following random 256-state reversible inverter in Matlab origin-1 was used as seed for the self-propagating inverter: [43 208 200 12 143 174 133 33 165 25 184 217 227 146 191 154 212 235 226 88 91 206 70 177 132 162 150 10 20 96 241 107 27 29 196 210 101 124 194 62 236 221 34 185 53 21 245 152 37 149 169 46 108 19 65 140 98 244 155 84 156 251 23 57 209 240 102 151 54 246 167 52 148 190 36 104 231 6 22 73 32 4 16 198 110 79 125 35 67 115 127 58 176 13 195 80 74 41 94 254 158 225 99 255 173 179 189 186 178 256 166 66 103 121 89 30 193 175 145 233 90 139 219 203 142 222 5 180 1 118 135 249 250 75 82 50 170 213 55 86 26 68 172 171 160 44 60 134 97 85 7 202 228 168 116 214 122 113 204 215 153 131 128 138 64 39 230 220 144 252 76 182 109 223 120 205 14 192 77 17 9 137 197 159 78 48 237 15 95 239 161 243 188 51 229 253 8 105 69 45 181 218 71 248 11 49 63 201 247 56 28 72 100 242 164 83 114 59 216 183 207 157 93 123 147 18 3 129 92 238 211 24 47 119 38 42 199 232 234 81 224 2 187 136 141 40 87 112 111 163 117 106 61 126 130 31].

The inventor recognizes the large sets of data used as illustration. However, practically copying the data into Matlab will facilitate processing. Furthermore, once data has been entered, processing with Matlab will not be hampered by the relatively small size of functions, text and inverters.

The size of 64 bytes input (or 512 bits) has been selected, because SHA-256 processes blocks of 512 bits which makes the process very efficient. However, for variation one may use larger block inputs of course or smaller ones, as is fully contemplated.

The following provides the six (6) 256-bit hashes of consecutive hashes using the different instances of the self-propagating 256-state inverter, but not changing the SHA-256 hash with the FLT of the new inverter.
‘FD7F6A243267C9D3631879BC3C6B9CD3E0B5BA7A743BD3DBD45C932B2BF04F 20’
‘EA1E57B423C4C497963014E325B246EFD1117C29C891A5EDCDE52E9258F35C10’
‘B2D7ACBE7C549BFF09A2DF4FA04C78986A203CFECBAE963E5C157E113DB757C5’
‘B470BBA25D173B284BF8875B296BD55DB8FC67A2882A5B30CD88EC7DFF707329’
‘159A3C9E1D2C477C7BF610C39A8FA5DIE1C781601B39A059F892780D8467DIFD’
‘57A559B7238FCCE8A81C4147EE58A25ADOF58699220AA50BBB51682793055CEl’

The following provides the 6 consecutive hashes with SHA-256 modified each time by FLT as described above using the newly generated inverter invn.
‘436457A676C5C801BBC54A69A9B2F570A1FF60F3A3CEE571920AC9C997D98DC6’
‘AD852C74E84061DE2258917B5E03368529D3943CD7312B5805F7E7B784B33DE9’
‘08251FAF4C16C8E29B15488457A2F5E50A60CC270837314B74AF25EB94D958B4’
‘3D90BFD1603046761B3419C361083F54B8CA5A6315B8642DF091DF360CAC037E’
‘DF010989D90226E087421964BA167F36F639AF90ADF69D7E081E81DF13DOB8F5’
‘99C5CCA20C50267378C826795525442CD2F052F409C5BFCE1FBED2B636CFF67C’

This forms an additional security layer that is infeasible to break. It creates a dynamic change in the applied cryptographic method or primitive. The number of possible variations is enormous in the order of 10\hat{ }500 per change. Furthermore, additional changes cumulate exponentially. This makes the modified primitives and other FLT/CFT modified cryptography theoretically close to unbreakable. Each implementation by applying the modification that for all practical purposes gets the properties of a one-time-pad (OTP). Astronomically large, these numbers are a consequence of combinatorial explosion. By creating a modification that applies the combinatorial explosion these astronomical variations are achieved. The numbers are not merely wishful thinking, but fully supported by combinatorics.

The inventor did execute the above illustrative approach for about one million cycles in a Matlab program on a standard Windows 10 PC, and checked for possible repeat outcomes, but did not find any repeats.

SHA-256/512 and other SHA modes have a great number of different transformation points. The addition mod-2\hat{ }32 is for instance applied numerous times in the processing and may be transformed for instance by FLT individually or in combination with different or identical FLTs. Furthermore, in case of modifying addition mod-2\hat{ }32 based on radix-256 representation, one may also replace the carry with a random looking 256-state function. Herein, the carry function may have any of 256-state elements and be different for input combinations. And furthermore, there are 64 or more rounds in SHA-256/512, offering even greater variations.

The introduction of self-propagating n-state inverters herein, described by Matlab expressions invn=invn(inv256); and/or invn=inv256(invn) and/or other propagating mechanisms with an initial seed inv256 for n=256, indicates a virtually unlimited source of generating different n-state reversible inverters to be applied to different n-state transforms. This enabled a dynamically changing encryption process wherein each block or set of blocks may be encrypted/decrypted by different functional implementations and/or methods. Making brute force attacks infeasible. The herein provided approach expands a received relatively short secret key into a longer, for instance 256 bytes sequence. The expanded sequence likely has duplicates and thus missing n-state elements and is not reversible. The method to change the 256-bytes sequence into an n-state reversible inverter provides a seed for a self-propagating n-state inverter. This allows the use and integration of the CFT methods and devices into the currently known and operated Public Key Infrastructure (PKI). The PKI handshake exchange and protocols are described in TLS 1.3 and can be found in detail in standards: 1) ISO/IEC 27099:2022: This international standard provides a framework for PKI practices and policies, covering certificate policies, certificate practice statements, and security management systems; 2) OASIS PKI Technical Standards: A comprehensive collection of PKI-related standards, including RFCs from the IETF, ANSI financial industry standards, and European electronic signature standards; 3) Microsoft's PKI Implementation Guide: A detailed guide on designing and implementing a PKI, covering planning, certificate authority setup, and security considerations. There are several packages that provide PKI. OpenSSL provides two key libraries: libssl for implementing TLS/SSL protocols and libcrypto for general-purpose cryptography.

One may modify the cryptographic operations in packages like libcrypto to implement the CFT aspects as disclosed herein.

While commonly AES-CTR or AES-GCM and ChaCha20 and related/known versions or modes are applied to generate the keystream, one may apply other methods, applying aspects of the present invention to create fast, secure and highly unpredictable keystreams. In effect one has access to a virtually unlimited number of n-state reversible inverters. One may assume that the PKI key (usually 32 bytes) and for instance generated by PQ method Kyber (FIPS 203) is secure. Assume a first block of 256 bytes of plaintext, though other sizes may be used. The key is transformed to a secure 256-state reversible inverter. The inverter may be applied to the elements of the plaintext. In one embodiment, one may create a cascade of 64 byte (like SHA-512 or SHA3-512) hashes to the generated inverter in a cascade of 4 consecutive hashes that are then concatenated into 256 bytes. Other key expanders as described earlier may be used also. This creates a secure keystream of 256 bytes.

The plaintext of 256 bytes may be combined with the keystream. The combining may be done by simple XORing or by any of the other combining functions which may be formed by applying a herein described or other CFT or transformation. This creates a first block of 256 bytes of ciphertext. One may use a different n-state inverter (different from the CFT applied one) to be applied to the combining function or the original one. A different n-state inverter may be obtained by running the Matlab propagation, wherein the number of executions is managed and/or recorded to prevent unwanted duplicates. One may automatically run an inverter generating procedure to create the required parameters for a next block.

While for efficiency one may use one common PKI based key, one may preload other keys that may be applied or install a PKI procedure that creates at least 2 common secure keys and potentially common n-state inverters. In the alternative one may also modify a seed n-state inverter generation process to create a different n-state inverter from the same expanded sequence or use a different expansion procedure.

In accordance with an aspect of the present invention a first or start ciphertext block for instance of 256-bit or 512 bits long has been created that with matching keystream generation may be decrypted. In accordance with a further aspect of the present invention, the n-state CFT inverter created from a key is updated as described above by self-propagation of 1 or more steps. In a next step a new block of keystream is created based on inputting all or some part of the n-state inverter in a hashing procedure, for instance SHA-256 or SHA-512. One may use the same or another n-state inverter to CFT the hashing step and/or the combination step. How hashing can be CFTed was already explained in U.S. patent application Ser. No. 18/097,396 filed Jan. 16, 2023 to Peter Lablans which is incorporated herein by reference. As disclosed therein, one may FLT one of several functions in a hashing operation, among others the k-bit word XOR, the addition modulo 2\hat{ }32, and/or one of the composite functions.

While illustrated by way of SHA-256 hash, the dynamic modification of hashing as well as encryption, by using different instances from a seed inverter which is applied as a self-propagating inverter is fully contemplated. Also, the modification of the self-propagating seed inverter by shifts, mod-n additions and others for dynamic modification is contemplated. It is believed that no additional illustrative examples are needed for a person of ordinary skill to apply the modifications as described herein without undue experimentation. The illustrative examples are provided in Matlab, which is close to pseudo-code. One of ordinary code may convert this into other computer program type instructions, which beyond common required knowledge and skills in computer programming does not create any undue need for experimentation, only basic programming skills.

Speeds of 50 ns per block are achievable. A typical ACH transactions (like direct deposits or bill payments) typically range from a few KB to tens of KB. And wire transfers contain more detailed information but still usually stay within hundreds of KB. Even blockchain transactions stay generally with 100 KB size. For transactions that require ultra-high security, the above dynamically changing keystream generation would be applicable. Other variations may be applied, including modification of combining functions in encryption/decryption steps.

FIPS documents are Federal Information Processing Standards issued through the National Institute of Standards and Technology in Maryland. NIST also issues Special Publications which are recommendations on cryptography. It is assumed that one of ordinary skill in the art of cryptography is familiar both with the content of FIPS and SP documents issued by NIST. These known documents include FIPS 180-4, FIPS 186-4, FIPS 197, FIPS 202, FIPS 203, FIPS 204. Furthermore, NIST Special Publications SP 800-38A SP 800-38B, SP 800-38C, SP 800-38D, SP 800-38E and SP 800-38F. ChaCha20 is fully described in for instance RFC 7539. Other standards in Cybersecurity as well as their implementation in software such as OpenSSL, Microsoft CNG, Apple CryptoKit, and Bouncy Castle are widely known and well documented. Even if a PHOSITA has no detailed knowledge of a particular standard or implementation, these are available for perusal on-line. As such, access to the details of cryptographic standards and computer implementations, while possibly time consuming, does not create undue experimentation.

In case any text provided herein is different from documents incorporated herein by reference, the instant specification is to be relied upon over prior documents.

In accordance with an aspect of the present invention, modified cryptographic operations as taught herein are applied in cryptographic agility applications. Current persistent attacks by cyber criminals as well as other threats to security have created a need for what is called cryptographic agility (Crypto Agility). This requires a quick smooth and reliable switch between for instance different cryptographic primitives and/or Key Encapsulation Mechanism (KEMs). Supposedly, this will throw off cyber attackers and increase security. It is believed that current proposals for Crypto Agility are too complex and will not create long term security. The cryptographic solutions as provided in the instant document allow for smooth parameter based configuration of a single cryptographic primitive. These transformation-based modifications create immensely large solution spaces, are simple to implement and based on agile implementation of parameter driven configurations.

Agility may be achieved by preferably selective transformation of data and/or computer functions based on a reversible n-state inverter, with n preferably greater than 7. The agility is further achieved by dynamically modifying an initial reversible inverter. A seed inverter may be pre-loaded or stored in a memory. It may also be provided externally. One way to create a common seed inverter on different machines is by providing two or more machines with a common secret key, for instance by using a common Key Exchange process (PKI) such as a post-quantum method as provided in Kyber (FIPS 203). One may initiate more than one private key creation. A common private key (which may be 32 bytes, for instance) may be extended to a much longer sequence of elements. An earlier provided method may be applied to modify an extended sequence into a reversible inverter. This created inverter may be a seed inverter or a basis for extracting a smaller reversible inverter. A reversible inverter may be used to generate derived reversible inverters by what is called herein self-propagating inverters. While one may propagate inverters in singles steps for application in transformations, one may use multi-step self-propagation to further make prediction of a reversible inverter more difficult. This enables a secret, smooth, easy to implement, autonomous and dynamic way to create modified cryptographic primitives that maintain a constant or almost constant dataflow or architecture while changing output by varying implementation. And hence achieves secure and fluid cryptographic agility.

Depending on requirements of security, one may want to transform a computer function like an addition over GF(n) or an n-state involution or other, on a message or session level, or more granular, like a packet level, a message block level or even on a round level. The inventor has experimented with Matlab, C and Python up to round level and block level modification. As far as the inventor could check, the modifications are relatively simple and easily performed and extremely fast, especially when look-up tables are applied. Using Matlab tic-toc execution instruction elapsed time of program execution is transformed LUTs are faster than standard word XORing. Furthermore, the structure of rounds and blocks provides sufficient time for a processor or processor core to determine a next n-state reversible inverter to enable a novel and different transformation. Thus the transformation itself as best understood does not form a bottleneck for the processing of a cryptographic process. Thus, if a cryptographic process in its unmodified state runs real-time, its modified or transformed version will also real-time. Real-time herein means that a processing of a message is not limited by a cryptographic operation.

Many files or messages are cryptographically processed in bulk in its entirety and may experience some delay before being transmitted. Application of the transformation does not affect the user experience. In the classical sense of real-time processing is the processing of a discrete sample of a sample at a speed that complies with the Nyquist criterion for signal reconstruction. This applies to realtime block and packet encryption/decryption, wherein the encryption and/or decryption of transformed computer functions does not create unwanted delay. Tests and analyses strongly suggest that no unwanted delays are created in round or block or packet level encryption decryption. Thus realtime transformations are achieved.

Quantum computing poses a significant threat to existing cryptographic systems, particularly public key infrastructure (PKI) methods. Emerging concerns have also been raised regarding the resilience of symmetric encryption algorithms. At the time of this invention, no publicly disclosed breakthroughs in novel symmetric encryption schemes have addressed these vulnerabilities. However, given the widespread reliance on primitives such as AES and ChaCha20 for secure data exchange and storage, any compromise in their integrity could have far-reaching consequences.

The transformations disclosed herein are believed to offer a vast solution space that enhances resistance to both current and anticipated cryptographic attacks. This approach may substantially extend the effective lifecycle of existing encryption primitives. When implemented appropriately, it is expected to preserve the confidentiality and integrity of encrypted data well into the future.

In accordance with one or more aspects of the present invention and as disclosed extensively above, novel and believed non-obvious computer functionality has been introduced, especially as applied in machine cryptography. A computer may construct a (like 256 bit) common key or sequence which may also be constructed by another computing device. The Sequence is expanded, for instance to an equivalence of at least 256 bytes or 2048 bits using an expansion method. This new longer sequence most likely when considered as a sequence of bytes has duplicates. A computer process removes duplicates and replaces them with missing bytes. An n-state reversible inverter has n n-state different elements. Preferably one works with n-state elements that are n=2\hat{ }k with k greater than 3 and n greater than 8. One may generate a 500-state reversible inverter and reduce it simply to a 256-state (or r-state with r=256) inverter. The r-state reversible inverter may be used to modify an r-state data element or to modify an r-state 2 operand operation with for instance an r-state Finite Lab Transform or an r-state ripple carry operation called a radix-r operation with a r-state residue and r-state carry determined by r-state 2 operand operations or functions.

One may replace known base functions with another base function that retains important properties but have different outputs. Different r-state carry functions are an example. One may also replace the standard 2 operand r-state addition over a finite field (like the addition over GF(256)) with a 2 operand r-state commutative involution that is still a 256-state commutative involution but for instance is not associative and thus not an addition over GF(256). One may use an initially generated reversible inverter as a seed inverter that may generate millions if not 100 of million and even more than 1 billion different reversible inverters, all originating from a seed inverter which itself originates from a relatively small initial sequence. Preferably one applies one or more processors or cores that process at least 1 million bytes per second and output a signal of at least 1000 bytes per second on a physical transmission channel to another computer. One of ordinary skill would realize that no person, even with paper and pencil, is able to perform those tasks.

The inventor herein applies the architecture/implementation/realization framework of his late Professor Dr. Gerrit Blaauw. However, Dr. Blaauw applied a common architecture over different generations of realization and implementations to retain compatibility of output over different generations of computers. The inventor retains a common architecture or data flow for instance of AES-GCM, because the strength and security (confusion and diffusion). But the inventor changes or transforms the implementation of functional parts that leave the data flow or architecture intact, but drastically changes its output. The inventor enables an immense variation space (about 10\hat{ }500 for n=256) based on novel transformations and combinatorial explosion. In that sense the current approach is significant different from the Blaauw framework in that it deliberately prevents commonality in implementation (rather than maintaining it) while preserving a proven and tested architecture.

Herein the term carry function and borrow function and n-state carry function and n-state borrow function are used. These terms are often used in the context of radix-n addition and subtraction or ripple carry operations. An n-state carry function is in effect an n-state transition function. The transition function determines an output or transition element based on 2 n-state operands from different words of operands, each word preferably having 2 or more n-state elements that each may become an operand, both for residue and transition purposes. The input operands are preferably selected as word elements in corresponding positions in the two words. The output of the transition function is a transition element and is processed in a next position of operands in a result word, which may be an intermediate word. When corresponding residue functions are derived from an addition over GF(n) or from an addition modulo-n or from a commutative n-state involution, one may call the transition function a carry function and the output an n-state carry. An operation that reverses such operations may be called a subtraction and the transition function may be called a borrow function and the transition element an n-state borrow element. It should be clear that the function being an addition or subtraction in the context of cryptography especially as it relates to commutative involutions may be irrelevant as subtraction and addition are the same. The carry and borrow become only relevant when a radix-n operation needs to be reversed. However, for one-way operations such as hashing and keystream generation there is no real relevance in naming difference. The names carry and borrow will be used herein also after the functions have been FLTed.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention.

1. A computer implemented method for cryptographic data processing, comprising:
generating, by one or more processors, from a sequence represented by p bits an n-state reversible inverter of n n-state elements, with n an integer n=2\hat{ }k greater than 8 and k greater than 3 and p being smaller than n*k;
transforming, by the one or more processors, a computer function characterized by an operation on a word of bits in a cryptographic operation based on the n-state reversible inverter, the cryptographic operation is selected from the group consisting of an encryption, a hashing, a public key exchange, a digital signature generation; and
transmitting data generated based on the cryptographic operation on a physical channel to another computing device.

2. The computer-implemented method of claim 1, wherein n is an integer greater than 127.

3. The computer-implemented method of claim 1, further comprising the cryptographic operation being an encryption and the one or more processors modifying a 2 operand computer function based on the reversible n-state inverter.

4. The computer-implemented method of claim 1, wherein the cryptographic operation is an encryption and the one or more processors modifying a set of 2 or more bits by an inversion based on the reversible n-state inverter.

5. The computer-implemented method of claim 1, wherein the cryptographic operation is an encryption and the one or more processors shuffling a set of 2 or more bits based on the reversible n-state inverter.

6. The computer-implemented method of claim 1, further comprising the one or more processors generating a next n-state reversible inverter based on the n-state reversible inverter.

7. The computer-implemented method of claim 1, further comprising the one or more processors generating a new n-state reversible inverter by a lexicographical permutation of at least a part of prior n-state reversible inverter.

8. The computer-implemented method of claim 1, wherein the sequence represented by p bits is a Public Key Infrastructure (PKI) defined key.

9. The computer-implemented method of claim 1, further comprising:
the one or more processors expanding the sequence of p bits to a sequence of at least n*k bits;
the one or more processors determining duplicate n-state elements and missing n-state elements in the sequence of at least n*k bits; and
the one or more processors replacing a duplicate n-state element with a missing n-state element.

10. The computer-implemented method of claim 1, wherein the n-state reversible inverter is reduced to an r-state reversible inverter and the computer function is an r-state computer function with r<n.

11. The computer-implemented method of claim 1, wherein transforming, by the one or more processors of the computer function is performed by a Finite Lab Transform.

12. The computer-implemented method of claim 1, wherein the computer function is characterized as a 2-operand commutative involution or self-reversing function that does not comply with all requirements of an addition over a finite field.

13. The computer-implemented method of claim 1, wherein transforming, by the one or more processors of the computer function includes a carry-function.

14. A cryptographic data processing device, comprising:
one or more processors;
one or more memory devices, configured to provide instructions to the one or more processors to perform the steps:
generating, from a sequence represented by p bits an n-state reversible inverter of n n-state elements, with n an integer n=2\hat{ }k greater than 8 and k greater than 3 and p being smaller than n*k;
transforming, by the one or more processors, a computer function characterized by an operation on a word of bits in a cryptographic operation based on the n-state reversible inverter, the cryptographic operation is selected from the group consisting of an encryption, a hashing, a public key exchange, a digital signature generation; and
transmitting data generated based on the cryptographic operation on a physical channel to another computing device.

15. The cryptographic data processing device of claim 14, wherein n is an integer greater than 127.

16. The cryptographic data processing device of claim 14, wherein the cryptographic operation is an ASCON encryption as defined in National Institute of Standards and Technology Special Publication SP.800-232 and a 2 operand computer function is modified based on the reversible n-state inverter.

17. The cryptographic data processing device of claim 14, further comprising the step generating a next n-state reversible inverter based on the n-state reversible inverter.

18. The cryptographic data processing device of claim 14, wherein the sequence represented by p bits is a Public Key Infrastructure (PKI) defined key.

19. The cryptographic data processing device of claim 14, wherein the computer function is characterized as a 2-operand commutative involution or self-reversing function that does not comply with all requirements of an addition over a finite field.

20. The cryptographic data processing device of claim 14, wherein transforming, by the one or more processors of the computer function includes a carry-function.
